(19) United States
(12) Patent Application Publication
(10) Pub. No.: US 2004/0106707 A1
(43) Pub. Date: Jun. 3, 2004

(54) Protective coatings and methods of applying and using the same

(76) Inventors: Kai Su, Alpharetta, GA (US); Debbie Makita, Suwanee, GA (US)

Correspondence Address: Merchant & Gould P.C., P.O. Box 2903, Minneapolis, MN, 55402-0903, US

(21) Appl. No.: 10/712,704

(22) Filed: Nov. 13, 2003

Related U.S. Application Data
(60) Provisional application No. 60/426,031, filed on Nov. 13, 2002.

(51) Int. Cl. C08K 5/34; C08K 5/24; C08K 5/06

(52) U.S. Cl. 524/105; 524/261; 524/366

(57) ABSTRACT

Protective coatings are disclosed. Methods of applying the protective coatings are also disclosed.

### CROSS REFERENCE TO RELATED APPLICATIONS

The present invention claims the benefit of priority to U.S. Provisional Application Serial No. 60/426,031 filed on Nov. 13, 2002, the subject matter of which is hereby incorporated herein in its entirety.

### FIELD OF THE INVENTION

The present invention relates to protective coatings that provide at least one of the following properties: increased durability, scratch resistance, chemical resistance, and water resistance to surfaces coated with the protective coatings.

### BACKGROUND OF THE INVENTION

There is a need in the art for protective coatings having one or more of the following properties: (1) an ability to bond to substrates including, but not limited to, plastics, metals, glass, and combinations thereof, (2) an ability to provide scratch-resistance, chemical-resistance, corrosion-resistance, and/or water-resistance to a substrate, (3) an ability to repair damage to a given substrate such as damage from abrasion or water, and (4) an ability to be applied to a substrate in an environmentally friendly manner. Further, there is a need in the art for methods of applying protective coatings to substrates such as plastics, metals and glass in a cost-effective, environmentally friendly manner.

### SUMMARY OF THE INVENTION

The present invention addresses some of the difficulties and problems discussed above by the discovery of pad printable curable protective coatings for applying to a variety of substrates such as plastics, metals, and glass. The pad printable curable protective coatings contain a relatively low amount of volatile material, based on a total weight of the curable protective coating. In one exemplary embodiment of the present invention, the curable protective coating contains less than 20 percent by weight of volatile material, based on a total weight of the curable protective coating. In other exemplary embodiments of the present invention, the curable protective coating contains less than 3.0 percent by weight of volatile material, based on a total weight of the curable protective coating.

The curable protective coatings of the present invention comprise at least one adhesion promoter. Suitable adhesion promoters include, but are not limited to, glycol ethers, glycol ether acetates, benzotriazole, silanes, and combinations thereof. The curable protective coatings of the present invention may further comprise at least one polymerizable material and at least one polymerization initiator. When exposed to radiation, such as ultraviolet (UV) light, the curable protective coatings of the present invention form a cured protective coating that provides scratch-resistance, chemical-resistance, corrosion-resistance, and/or water-resistance to a given substrate.

The present invention is further directed to methods of providing a protective coating to a substrate, wherein the method comprises pad printing a curable protective coating onto a substrate. The methods of the present invention may further comprise a number of substrate preparation steps, protective coating preparation steps, and post-coating steps, such as a drying and/or curing step, depending on the substrate to be coated.

The present invention is even further directed to articles of manufacture, wherein at least a portion of the article comprises a coated substrate having a protective coating thereon. The coated substrate may be coated via a pad printing method of the present invention, and subsequently treated to form a cured protective coating on at least a portion of the article. The method of the present invention may be used to form coated articles including, but not limited to, optical lenses, eyeglasses, contact lenses, credit cards, golf balls, cellphone displays, automotive displays, personal data assistants (PDAs), pagers, video games, or any other article having an optically clear component.

These and other features and advantages of the present invention will become apparent after a review of the following detailed description of the disclosed embodiments and the appended claims.

### BRIEF DESCRIPTION OF THE FIGURES

FIG. 1 is a perspective view of an exemplary apparatus for applying a protective coating of the present invention to an optical surface;

FIG. 2 is a cross-sectional view of part of the exemplary apparatus for applying a protective coating to an optical surface as shown in FIG. 1;

FIG. 3 is a cross-sectional view of an exemplary transfer pad applying a protective coating of the present invention to an optical surface in one embodiment of the present invention;

FIG. 4 is a cross-sectional view of an exemplary transfer pad applying a protective coating of the present invention to an optical surface in an alternative embodiment of the present invention;

FIGS. 5A-5F schematically show an exemplary process of using a transfer pad to apply a protective coating of the present invention to an optical surface;

FIG. 6 is a perspective view of an exemplary coating station suitable for use in the present invention;

FIG. 7 schematically shows an exemplary process of applying a protective coating of the present invention to an optical surface in an automation line;

FIG. 8 is a side view of applying a protective coating of the present invention to an optical device from both sides in an exemplary embodiment of the present invention;

FIG. 9 is a side view of curing the coated optical device of FIG. 8;

FIG. 10 is a side view of applying a protective coating of the present invention to an optical device when the cliche and the reservoir are in a relative motion in one exemplary embodiment of the present invention;

FIG. 11A is a perspective view of an exemplary coating screen suitable for use in one exemplary embodiment of the present invention;

FIG. 11B is a top view of the exemplary coating screen of FIG. 11A; and

FIGS. 12A-12B schematically show an exemplary process of using a transfer pad and the coating screen of FIG. 11A to apply a protective coating to an optical surface in one exemplary embodiment of the present invention.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

The present invention is directed to protective coatings for treating a surface of a substrate. The protective coating may be used to prevent damage to a given substrate and/or repair damage already done to a given substrate. The present invention is also directed to methods of providing a protective coating onto a surface of a substrate.

I. Protective Coatings

The protective coatings of the present invention may comprise one or more of the following components: one or more adhesion promoters, one or more polymerizable materials, one or more polymerization initiators, and one or more optional additives. A description of each protective coating component is provided below.

1. Adhesion Promoters

The protective coatings of the present invention comprise one or more of adhesion promoters. Suitable adhesion promoters include, but are not limited to, components that chemically etch, soften, or react with an outer surface of a substrate, yet do not significantly alter the transparency or bulk physical properties of the substrate. For example, without intending to be bound by theory, it is believed that the adhesion promoter, when used on a plastic substrate, disrupts the surface of the treated plastic surface allowing a hard coat pre-polymer (i.e., polymerizable material) to leach into the disrupted surface of the plastic substrate.

A variety of adhesion promoters may be used in the present invention depending on a number of factors including, but not limited to, the substrate to be coated. One class of suitable adhesion promoters includes, but is not limited to, glycol ethers having a formula:

CₓH₂ₓ₊₁O[CH₂CH(CH₃)O]ₙCₘH₂ₘ₊₁

wherein x is an integer from 1 to 4, n is either 1 or 2, and m is either 0 or 1. Suitable glycol ethers include, but are not limited to, dipropylene glycol dimethyl ether. Another class of suitable adhesion promoters includes, but is not limited to, glycol ether acetates having a formula:

CₓH₂ₓ₊₁O[CH₂CH(CH₃)O]ₙC(O)CₘH₂ₘ₊₁

wherein x is an integer from 1 to 4, n is either 1 or 2, and m is either 0 or 1. Suitable glycol ether acetates include, but are not limited to, propylene glycol methyl ether acetate. Other suitable adhesion promoters include, but are not limited to, benzotriazole or functionalized benzotriazole such as tolytriazole, silanes, or a combination of any of the above-mentioned adhesion promoters.

A number of commercially available adhesion promoters may be used in the protective coatings of the present invention. Examples of commercially available adhesion promoters include, but are not limited to, glycol ether acetates commercially available from Dow Chemical Company (Midland, Mich.) under the trade designation DOWANOL®, such as DOWANOL® PMA (i.e., propylene glycol methyl ether acetate), DOWANOL® DPMA (diproplyene glycol methyl ether acetate), and glycol ethers commercially available from Dow Chemical Company (Midland, Mich.) under the trade designation PROGLYDE®, such as PROGLYDE® DMM (i.e., dipropylene glycol dimethyl ether), DOWANOL® PM (propylene glycol methyl ether), DOWANOL® DPM (dipropylene glycol methyl ether,) DOWANOL® PnP (propylene glycol n-propyl ether), DOWANOL® PnB (propylene glycol n-butyl ether), and DOWANOL® DPnP (dipropylene glycol n-propyl ether).

Suitable commercially available silanes include, but are not limited to, silanes commercially available from DeGussa Chemical (Parsippany, N.J.) under the trade designation DYNASYLAN®, such as DYNASYLAN® 1189 (i.e., N-(n-butyl)-3-aminopropyltrimethyl-siloxane), DYNASYLAN® GLYMO (i.e., 3-glycidyloxypropyltri-methoxysilane), DYNASYLAN® MEMO (i.e., 3-methacryloxypropyl-trimethoxysilane), DYNASYLAN® MTMO (i.e., 3-mercaptopropyl-trimethoxysilane), and DYNASYLAN® VTEO (i.e., vinyltriethoxy-silane).

Typically, the one or more adhesion promoters are present in the protective coatings of the present invention in an amount of up to about 20 percent by weight (pbw) based on a total weight of the protective coating. Desirably, the one or more adhesion promoters are present in the protective coatings of the present invention in an amount ranging from about 0.1 pbw to about 20 pbw, more desirably, from about 0.1 pbw to about 3.0 pbw based on a total weight of the protective coating.

2. Polymerizable Materials

The protective coatings of the present invention may also comprise one or more of polymerizable materials. Suitable polymerizable materials include any material that polymerizes when exposed to heat or light in the presence of a polymerization initiator.

Suitable polymerizable materials include, but not limited to, acrylates, methacrylates, urethane acrylates, vinyl-terminated molecules, silicone acrylates, epoxies, and combinations thereof. Desirably, the polymerizable material comprises dipentaerythritol hydroxy pentaacrylate (DPHPA), tripropylene glycol diacrylate (TRPGDA), an aliphatic urethane hexaacrylate, a ditrimethylolpropane tetraacrylate, an acrylic functional, polyester modified dimethylpolysiloxane, or combinations thereof.

A number of commercially available polymerizable materials may be used in the protective coatings of the present invention. Examples of commercially available polymerizable materials include, but are not limited to, acrylates commercially available from UCB Chemicals (Smyrna, Ga.) under the trade designation EBECRYL® DPHPA (i.e., dipentaerythritol hydroxy pentaacrylate), and EBECRYL® TRPGDA (i.e., tripropylene glycol diacrylate); modified aliphatic urethanes commercially available from UCB Chemicals (Smyrna, Ga.) under the trade designations EB-8301 and EB 1290; and acrylic functional, polyester modified dimethylpolysiloxanes commercially available from BYK Chemie (Wallingford, Conn.) under the trade designations BYK 371, BYK 300, BYK 301, BYK 306, BYK 307, BYK 333, BYK 340, BYK 341, BYK 352, BYK 355, BYK 357, BYK 358N, BYK 361, and BYK 392.

Typically, the one or more polymerizable materials are present in the protective coatings of the present invention in an amount of up to about 95 percent by weight (pbw) based on a total weight of the protective coating. Desirably, the one or more polymerizable materials are present in the protective coatings of the present invention in an amount ranging from about 70 pbw to about 95 pbw, more desirably, from about 80 pbw to about 90 pbw based on a total weight of the protective coating.

3. Polymerization Initiators

The protective coatings of the present invention may further comprise one or more of polymerization initiators. Suitable polymerization initiators include any material that initiates polymerization of the above-described polymerizable materials when exposed to heat or light.

Suitable polymerization initiators include, but not limited to, light-activated initiators disclosed in U.S. Pat. Nos. 4,735,632 (Oxman et al.) and 5,674,122 (Klun et al.); cationic initiators including salts of onium cations, such as arylsulfonium salts, organometallic salts, such as ion arene systems, and others disclosed in U.S. Pat. Nos. 4,751,138 (Tumey et al.), 5,256,170 (Harmer et al.), 4,985,340 (Palazotto), and 4,950,696, the disclosures of all of which are hereby incorporated by reference.

Examples of specific initiators suitable for use in the present invention, include, but are not limited to, 2-hydroxy-2-methyl-1-phenylpropan-1-one, 1-hydroxycyclohexyl phenyl ketone, 2,2-di-sec-butoxyacetophenone, benzoin, 2,2-diethoxyacetophenone, 2,2-diethoxy-2-phenyl-acetophenone, benzil, 2,2-dimethoxy-2-phenyl-acetophenone, methyl benzoylformate, benzoin methyl ether, benzoin isobutyl ether, benzyl disulfide, 2,4-dihydroxybenzophenone, benzylideneacetophenone, benzophenone, acetophenone, and combinations thereof. Other radical scavengers or oxygen scavengers, such as triphenylphosphine, may be used synergistically with the above-mentioned intitiators to reduce/eliminate the oxygen inhibition during the cure cycle. Desirably, the polymerization initiator comprises one or more photoinitiators.

A number of commercially available polymerization initiators may be used in the protective coatings of the present invention. Examples of commercially available polymerization initiators include, but are not limited to, photoinitiator commercially available under the trade designations DAROCUR®, such as DAROCUR® 1173 from Merck Chemicals (Germany); and IRGACURE®, such as IRGACURE® 907, IRGACURE® 651, and IRGACURE® 184 from Ciba Geigy Specialty Chemicals (Tarrytown, N.Y.).

Typically, the one or more polymerization initiators are present in the protective coatings of the present invention in an amount of up to about 10 percent by weight (pbw) based on a total weight of the protective coating. Desirably, the one or more polymerization initiators are present in the protective coatings of the present invention in an amount ranging from about 1.0 pbw to about 10.0 pbw, more desirably, from about 2.0 pbw to about 5.0 pbw based on a total weight of the protective coating.

4. Optional Additives

The protective coatings of the present invention may further comprise one or more of optional additives. Suitable optional additives include any material that provides one or more desired properties to the protective coating. Suitable optional additives include, but not limited to, organic dyes (visible, IR, or optical brighteners), materials that assist in the absorption of dye material into the polymerized matrix; and combinations thereof.

When present, the one or more optional additives are typically present in the protective coatings of the present invention in an amount of up to about 50 percent by weight (pbw) based on a total weight of the protective coating. Desirably, when present, the one or more optional additives are present in the protective coatings of the present invention in an amount ranging from about 1.0 pbw to about 20 pbw, more desirably, from about 1.0 pbw to about 10 pbw based on a total weight of the protective coating.

II. Substrates to be Coated

The protective coatings of the present invention may be applied to a variety of substrates including, but not limited to, plastics, metals, glass, and combinations thereof. The protective coatings of the present invention may be used to “pre-treat” a surface of a substrate before any use, after some use, or to “repair” a surface of a substrate that has been scratched. In any of the above options, the resulting surface is more durable and resistant to future damage including scratching, corrosion and water-damage. For the reasons given above, the protective coatings of the present invention are particular useful to coat objects that are repeatedly handled, such as credit cards and view screens for electronic devices.

Objects that are repeatedly handled, such as credit cards and electronic devices, often lack sufficient durability to withstand such use without damage from scratching and the like. Similarly, inks used for marking objects such as keypads, control panels, and automotive dials often cannot withstand the repeated frictional and impact contact that is typically received during use. The protective coatings of the present invention improve the durability of such surfaces that are subjected to repeated handling and/or wear. Further, the protective coatings of the present invention protect images on such surfaces by “encapsulating” the image (i.e., marking ink pattern or logo) when the protective coating is applied over the mage. The protective coatings of the present invention provide such protection without requiring modification of the underlying substrate or its manufacturing technology.

Specific substrate materials that can benefit from the protective coatings of the present invention include, but are not limited to, plastics such as polymethylmethacrylate (“PMMA”), polycarbonate, polymerized diethylene glycol bis(allylcarbonate) (DAC), nylon, polyester, polypropylene and polyethylene; metals such as aluminum, steel, and yellow metals including copper, brass, and bronze; metal coated plastics such as a plastic film having an ion vapor deposited (IVD) metal coating thereon; and glass substrates.

In one embodiment of the present invention, the substrate comprises a plastic, such as polymethylmethacrylate (“PMMA”) or polycarbonate, and the protective coating comprises an adhesion promoter such as a glycol ether acetate (i.e., propylene glycol methyl ether acetate) or a glycol ether (i.e., dipropylene glycol dimethyl ether). In a further embodiment, the protective coating contains at least one adhesion promoter in combination with a hard coat base formula (described below). The hard coat base formula may be a radiation curable composition, such as a heat or light curable mixture comprising at least one multi-functional acrylate pre-polymer material and a light or thermal polymerization initiator.

The protective coating of the present invention may vary depending on a number of factors including, but not limited to, the type of substrate, the type of preparation of the substrate, and the end use of the coated substrate. For example, when the substrate comprises a plastic such as polymethylmethacrylate (PMMA), polycarbonate, polyethylene terephthalate (PET), nylon, polyester, and combinations thereof, it is desirable to coat the substrate with a curable protective coating containing at least one adhesion promoter comprising propylene glycol methyl ether acetate, and at least the following additional components: dipentaerythritol hydroxy pentaacrylate (DPHPA); tripropylene glycol diacrylate (TRPGDA); an aliphatic urethane hexaacrylate; an acrylic functional, polyester modified dimethylpolysiloxane; and a UV-curable photoinitiator. In this embodiment, the protective coating may further comprise a silicone acrylate, triphenylphosphine, and benzophenone. In this embodiment, triphenylphosphine (TPP) acts as an “oxygen scavenger,” bonding with any oxygen present to prevent the oxygen from slowing down the polymerization. Since oxygen is more present at the surface, the addition of TPP helps the surface cure better. In this embodiment, benzophenone acts as a photosensitizer by abstracting hydrogen from the reactive acrylate, and enhancing reactivity with other acrylates. Benzophenone has a synergistic effect with the other “photocleavable” photoinitiators present in the protective coating.

In other embodiments of the present invention, the substrate to be coated comprises a metal substrate such as an aluminum substrate. In these embodiments, it is desirable to coat the substrate with a curable protective coating containing an optional adhesion promoter, such as propylene glycol methyl ether acetate, and at least one of the following additional components: dipentaerythritol hydroxy pentaacrylate (DPHPA); tripropylene glycol diacrylate (TRPGDA); an aliphatic urethane hexaacrylate (e.g., EB 8301); an acrylic functional, polyester modified dimethylpolysiloxane (e.g., BYK 371; and at least one UV-curable photoinitiator. In this embodiment, the protective coating desirably further comprises a silane, such as 3-glycidyloxypropyltrimethoxysilane or 3-methacryl-oxypropyltrimethoxysilane. In this embodiment, the protective coating may further comprise a silicone acrylate, triphenylphosphine, and benzophenone.

In even further embodiments of the present invention, the substrate to be coated comprises a metal-coated plastic substrate. Suitable metal-coated plastic substrates include, but are not limited to, ion vapor deposited (IVD) aluminum-coated polycarbonate substrates. In these embodiments, it is desirable to coat the substrate with a primer coating comprising at least one silane, and on the primer coating, a curable protective coating containing at least one an adhesion promoter comprising propylene glycol methyl ether acetate, and at least the following additional components: dipentaerythritol hydroxy pentaacrylate (DPHPA); tripropylene glycol diacrylate (TRPGDA); an aliphatic urethane hexaacrylate (e.g., EB8301); an acrylic functional, polyester modified dimethylpolysiloxane (e.g., BYK 371); and a UV-curable photoinitiator. Desirably, the silane of the primer coating comprises 3-methacryloxypropyltrimethoxysilane. In this embodiment, the primer coating desirably further comprises isopropyl alcohol, glacial acetic acid or phosphoric acid, and deionized water. In this embodiment, the protective coating may further comprise a silicone acrylate, triphenylphosphine, and benzophenone.

In even further embodiments of the present invention, the substrate to be coated comprises a yellow metal, such as brass, bronze, and copper. In these embodiments, it is desirable to coat the substrate with a curable protective coating containing at least one an adhesion promoter comprising benzotriazole or a combination of benzotriazole and propylene glycol methyl ether acetate, and at least the following additional components: dipentaerythritol hydroxy pentaacrylate (DPHPA); tripropylene glycol diacrylate (TRPGDA); an aliphatic urethane hexaacrylate (e.g., EB 8301); an acrylic functional, polyester modified dimethylpolysiloxane; and a UV-curable photoinitiator. In this embodiment, the protective coating may further comprise a silicone acrylate, triphenylphosphine, and benzophenone. Further, in this embodiment, an optional primer coating may be used between the protective coating and the yellow metal surface. Suitable primer coatings comprise at least one silane, desirably, 3-methacryloxypropyltrimethoxysilane. In this embodiment, the primer coating may further comprise isopropyl alcohol, glacial acetic acid, and deionized water. In this embodiment, the primer contains a methacrylate group, which reacts with the protective coating material during a subsequent UV-curing process.

In even further embodiments of the present invention, the substrate to be coated comprises a glass substrate. In these embodiments, it is desirable to coat the substrate with a primer coating comprising at least one silane. In addition to the primer coating, a curable protective coating may be applied to the primer coating, wherein the curable protective coating optionally contains at least one adhesion promoter, such as propylene glycol methyl ether acetate, and at least the following additional components: dipentaerythritol hydroxy pentaacrylate (DPHPA); tripropylene glycol diacrylate (TRPGDA); an aliphatic urethane hexaacrylate (e.g., EB8301); an acrylic functional, polyester modified dimethylpolysiloxane (e.g., BYK 371); and a UV-curable photoinitiator. Desirably, the silane of the primer coating comprises 3-methacryloxypropyltrimethoxysilane. In this embodiment, the primer coating may further comprise isopropyl alcohol, glacial acetic acid or phosphoric acid, deionized water, or a combination thereof. In this embodiment, the protective coating may further comprise a silicone acrylate, triphenylphosphine, benzophenone, or a combination thereof.

Any of the above-described coated substrates may be incorporated into an article of manufacture or object. Objects formed from one or more of the above-mentioned plastic substrate materials include, but are not limited to, optical lenses having various prescription strengths (e.g., eyeglasses, contact lens), credit cards, and optical-grade plastic “parts.” As used herein, the term “optical-grade plastic parts” includes, but is not limited to, cellphone displays, automotive displays, personal data assistants (PDAs), pagers, children's video games, or any other part having a component that is optically clear. Typically, these optical-grade plastic parts are composed of a variety of types of plastics, including PMMA, polycarbonate, nylon, polyester, and possibly, polypropylene and polyethylene, or glass. Any of the above-mentioned objects may benefit from a protective coating to prolong its usable life and/or improve the ability to see through an optically clear component thereof during its usable life. Such protective coatings provide scratch resistance, as well as, chemical resistance.

Other objects formed from one or more of the above-mentioned metal substrate materials include, but are not limited to, metal coatings, films, and sheets. Protective coatings of the present invention provide scratch resistance, chemical resistance, as well as, corrosion resistance against oxidation (i.e., rust) or tarnishing.

III. Methods of Applying a Protective Coating

The present invention is further directed to methods of providing a protective coating onto a surface of a substrate. The protective coatings of the present invention may be applied to a given substrate using a variety of coating techniques. Desirably, the protective coatings of the present invention are applied to any of the above-described substrates using pad printing technology as described below.

A. Preparation of Protective Coatings

In a typical method of the present invention, a protective coating is prepared by combining a heat or light curable hard coat base formulation with at least one adhesion promoter, and the resulting protective coating mixture is then printed onto a surface of a substrate using pad printing technology. Thereafter, the printed coating is dried to evaporate any solvent, if present, and the coating is cured by light or heat to provide a finished surface that is more durable than the uncoated substrate.

In one desired embodiment of the present invention, the method of applying a protective coating to a given substrate comprises applying a protective coating via a pad printing process, wherein the protective coating comprises less than 20 percent by weight (pbw) of combined (i) solvent and (ii) adhesion promoters, based on a total weight of the protective coating. In some cases, the protective coating comprises less than 3.0 percent by weight (pbw) of combined (i) solvent and (ii) adhesion promoters, based on a total weight of the protective coating. Such low solvent formulae are more environmentally friendly and economical than solvent-based coatings. In fact, not only is there little or no solvent to evaporate with the present invention, there is also less waste generated by a pad print coating operation than in other coating processes known in the art, such as dip coating.

The protective coatings of the present invention typically comprise (i) a hard coat base formula in combination with (ii) at least one adhesion promoter. In one embodiment of the present invention, a hard coat base solution is formulated, and at least one adhesion promoter is subsequently added to the hard coat base solution to form a protective coating solution. Alternatively, the hard coat base solution components and at least one adhesion promoter are collectively formulated to provide the protective coating solution.

An example of the first option is provided below. An exemplary hard coat base solution having a solution composition as shown in Table 1 below is first prepared by mixing each of the components is a mixing vessel:

TABLE 1
Hard Coat Base Solution Composition

| Component | Weight Percent |
|---|---|
| DPHPA¹ | 40.0 |
| EB-8301² | 40.0 |
| TRPGDA³ | 10.0 |
| IRGACURE ® 907⁴ | 5.0 |
| BYK 371⁵ | 5.0 |
| | 100% |

¹DPHPA refers to dipentaerythritol hydroxy pentaacrylate commercially available from UCB Chemicals (Smyrna, GA);
²EB-8301 refers to an aliphatic urethane hexaacrylate commercially available from UCB Chemicals (Smyrna, GA);
³TRPGDA refers to tripropylene glycol diacrylate commercially available from UCB Chemicals (Smyrna, GA);
⁴IRGACURE ® 907 is a UV-curable photoinitiator commercially available from Ciba Geigy (Tarrytown, NY); and
⁵BYK 371 refers to a solution of an acrylic functional, polyester modified dimethylpolysiloxane commercially available from BYK Chemie (Wallingford, CT).

From the above exemplary hard coat base formulation, a variety of protective coatings of the present invention may be prepared by adding any desired amount of one or more adhesion promoters to the hard coat base formulation. For example, a first protective coating may be prepared by adding 10 pbw of an adhesion promoter, such as DOWANOL® PMA, a propylene glycol methyl ether acetate commercially available from Dow Chemical Company (Midland, Mich.). A second protective coating may be prepared by adding 20 pbw of the DOWANOL® PMA adhesion promoter or some other adhesion promoter.

Alternatively, exemplary protective coating formulations of the present invention may be prepared by simultaneously mixing the components as shown in Table 2 below:

TABLE 2
Protective Coating Solution Composition

| | PCS1 | | | |
|---|---|---|---|---|
| | Weight | PCS2 | PCS3 | |
| Component | (g) | Weight (g) | Weight (g) | PCS4 Weight (g) |
| EBECRYL ® | 50.0 g | 50.0 g | 50.0 g | 50.0 g |
| 40⁶ | | | | |
| EBECRYL ® | 45.0 g | 45.0 g | 45.0 g | 45.0 g |
| 1290⁷ | | | | |
| IRGACURE ® | 1.6 g | 1.6 g | 1.6 g | 1.6 g |
| 907 | | | | |
| DAROCUR ® | 3.4 g | 3.4 g | 3.4 g | 3.4 g |
| 1173⁸ | | | | |
| DOWANOL ® | 10.0 g | 20.0 g | — | — |
| PMA | | | | |
| PROGLYDE ® | — | — | 10.0 g | 20.0 g |
| DMM⁹ | | | | |
| | 110.0 g | 120.0 g | 110.0 g | 120.0 g |

⁶EBECRYL ® 40 refers to polyether tetraacrylate commercially available from UCB (Smyrna, GA);
⁷EBECRYL ® 1290 refers to aliphatic urethane hexaacrylate commercially available from UCB (Smyrna, GA);
⁸DAROCUR ® 1173 is a UV-curable photoinitiator commercially available from Ciba Geigy (Tarrytown, NY); and
⁹PROGLYDE ® DMM refers to dipropylene glycol dimethyl ether commercially available from Dow Chemical Company (Midland, MI).

The protective coating formulations as shown in Table 2 may be used as is in any of the methods of applying a protective coating described below.

The protective coating formulations of the present invention desirably possess a suitable viscosity such that the protective coating formulations may be pad printable on a given substrate. Most desirably, the protective coating formulations contain a minimal amount of solvent or other volatile components. As discussed above, it is desirable for the protective coating formulations to contain less than 20 pbw of volatile components (i.e., solvent and/or adhesion promoters) based on a total coating weight, and even more desirable, less than 3% pbw of volatile components (i.e., solvent and/or adhesion promoters) based on a total coating weight. Also, as discussed above, the protective coating formulations may further comprise one or more additives, such as dyes to provide a color or some other property to the resulting coating.

The protective coating formulations of the present invention are desirably applied to a given substrate using a pad printing process and apparatus. Suitable pad printing process and apparatus include, but are not limited to, pad printing process and apparatus identical to or similar to those disclosed in U.S. patent application Ser. No. 10/075,637, filed on Feb. 12, 2002 and entitled “Methods of Applying a Coating to an Optical Surface,” the subject matter of which is incorporated herein by reference in its entirety.

B. Preparation of Substrate Surface for Coating

In some embodiments of the present invention, it is desirable to perform one or more steps to prepare a given substrate for a subsequently applied protective coating. For example, metal substrates received from a manufacturer typically have an anti-tarnish coating or other finishing material on a surface of the metal substrate. Such coatings may negatively impact adhesion of the protective coatings of the present invention to the metal substrate surface. In order to improve adhesion of the protective coatings to the metal substrate, the anti-tarnish coating or other finishing material is removed from the surface of the metal substrate prior to coating with a protective coating.

Preparation of a given substrate for subsequent coating may be as simple as exposing the surface of the substrate to a pH neutral aqueous soap solution. The surface of the substrate may be soaked in a pH neutral aqueous soap solution or washed/scrubbed with the pH neutral aqueous soap solution. In other embodiments of the present invention, multiple steps may be used to prepare the surface for coating.

A number of process steps may be used to prepare a given substrate for a protective coating. Suitable steps include, but are not limited to, (i) contacting the surface of a given substrate with an aqueous pH neutral (i.e., an aqueous solution having a pH from about 6.5 to about 7.5, and desirably 7.0) soap solution; (ii) contacting the surface of a given substrate with a trisodium phosphate (TSP) solution; (iii) contacting the surface of a given substrate with an aqueous acidic solution; (iv) contacting the surface of a given substrate with a rinse of deionized water; (v) drying the surface of a given substrate after exposing the surface to one or more liquids; (vi) exposing the surface of a given substrate to a corona discharge process; (vii) scrubbing the surface of a given substrate with an abrasive material prior to or during exposure of the surface to a fluid including liquid, air, an acidic solution, or a combination thereof; and (viii) storing the substrate in a clean, dry, enclosed container to prevent contamination from dust or other particles.

In some embodiments of the present invention, a primer coating layer is applied to the substrate to further enhance adhesion between the substrate surface and a subsequently applied protective coating. For example, for ion vapor deposited (IVD) aluminum surfaces, such as IVD aluminum-coated polycarbonate surfaces, it is desirable to coat the IVD aluminum surface with a primer coating layer, and then apply a protective coating layer over at least a portion of the primer coating layer. Consequently, in some embodiments of the present invention, process steps used to prepare a given substrate for a protective coating may also comprise: (i) applying a primer coating onto the surface of a given substrate; (ii) removing any excess primer coating from the surface of a given substrate; and (iii) drying a primer coating on the surface of a given substrate.

Suitable primer coatings may include a variety of materials. Desirably, the primer coating comprises at least one silane. Suitable silanes include, but are not limited to, the silanes described above as suitable adhesion promoters. In addition to at least one silane, primer coatings may include an alcohol, such as isopropyl alcohol; an acid, such as glacial acetic acid; deionized water; or combinations thereof. In one exemplary embodiment, the primer coating comprises up to about 5.0 parts by weight (pbw), desirably, about 2.0 pbw, of one or more silanes; up to about 90.0 pbw, desirably, about 87.8 pbw, of isopropyl alcohol; up to about 1.0 pbw, desirably, about 0.2 pbw, of glacial acetic acid; and up to about 20.0 pbw, desirably, about 10.0 pbw, of deionized water.

In one embodiment of the present invention, the substrate to be coated comprises a plastic material, such as polymethylmethacrylate (PMMA), polycarbonate, polyethylene terephthalate (PET), nylon, polyester, polypropylene, polyethylene, or combinations thereof. In this embodiment, the process steps used to prepare a surface of the plastic substrate for a protective coating desirably comprise: (i) contacting the surface with an aqueous pH neutral (e.g., a pH of from about 6.5 to about 7.5, desirably 7.0) soap solution; (ii) contacting the surface with a rinse of deionized water; and (iii) drying the surface after exposing the surface to one or more liquids.

In a further embodiment of the present invention, the substrate to be coated comprises a metal substrate, such as an aluminum substrate. In this embodiment, the process steps used to prepare a surface of the metal substrate desirably comprise: (i) contacting the surface with an aqueous pH neutral soap solution; (ii) contacting the surface with a TSP solution; (iii) contacting the surface with an aqueous acidic solution (e.g., a 1.0 wt % HCl solution); (iv) contacting the surface with a rinse of deionized water; and (v) drying the surface after exposing the surface to one or more liquids.

In yet a further embodiment of the present invention, the substrate to be coated comprises a metal-coated plastic substrate, such as an IVD aluminum-coated polycarbonate substrate. In this embodiment, the process steps used to prepare a surface of the metal-coated plastic substrate desirably comprise: (i) contacting the surface with an aqueous pH neutral soap solution; (ii) contacting the surface with a TSP solution; (iii) contacting the surface with a rinse of deionized water; (iv) drying the surface after exposing the surface to one or more liquids; (v) applying a primer coating onto the surface; (vi) removing any excess primer coating from the surface; and (vii) drying the primer coating on the surface.

In yet a further embodiment of the present invention, the substrate to be coated comprises a yellow metal such as brass, bronze, copper, or combinations thereof. In this embodiment, the process steps used to prepare a surface of the yellow metal desirably comprises: (i) contacting the surface with an aqueous pH neutral soap solution; (ii) contacting the surface with a rinse of deionized water; (iii) drying the surface after exposing the surface to one or more liquids; (iv) optionally, scrubbing the surface with an abrasive material prior to, during, or after exposure to a fluid including liquid, air, an acidic solution (e.g., a phosphoric acid solution), or a combination thereof; and (v) contacting the surface with an aqueous acidic solution (e.g., an HCl acid solution).

C. Applying the Protective Coating

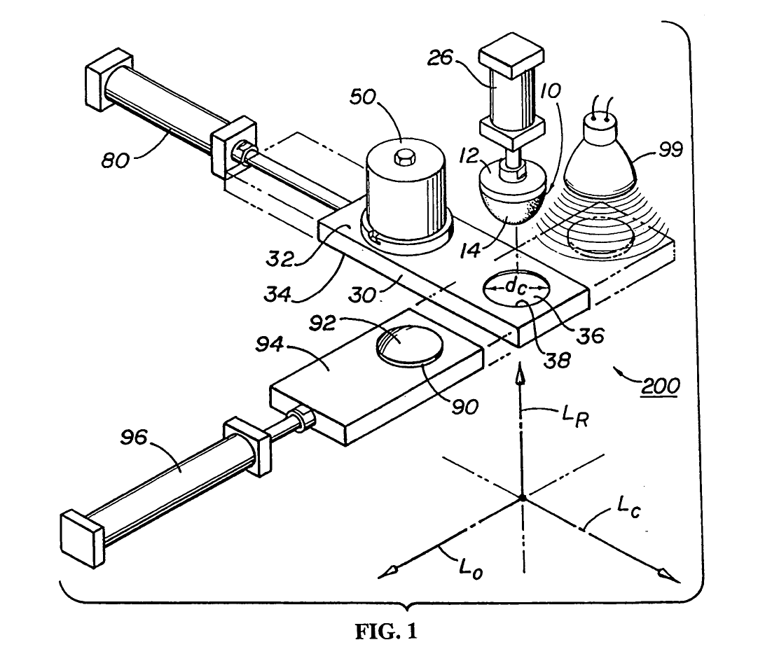

Referring now to FIGS. 1-12B, exemplary methods of applying a protective coating to a substrate according to the present invention are described. It should be noted that although the exemplary methods described herein involve applying a protective coating to an optical surface of an optical device, the exemplary methods may also be used to apply a protective coating to any of the above-mentioned substrates having a simple (i.e., flat) or complex (i.e., curved and/or not flat) surface shape. Further, the exemplary methods may also be used to apply a primer coating or any other coating, in addition to the protective coatings described above, to any of the above-mentioned substrates.

Exemplary apparatus 200 shown in FIG. 1 may be used to apply a protective coating of the present invention. In operation, as shown in the embodiment of FIGS. 1, 2 and 5A-5F, protective coating solution 40 is placed in cliche 36 of cliche plate 30. Cliche plate 30 has first surface 32, opposite second surface 34, and cliche 36 having annular edge 38. Cliche 36 may have a recess with a desired depth, typically about 15 to 20 microns in depth. Furthermore, cliche 36 may have any desired size and shape. As shown in FIG. 1, cliche 36 has an annular edge 38 and a circular shape having a diameter, d_{c}, which is typically in the range of 5 to 15 cm.

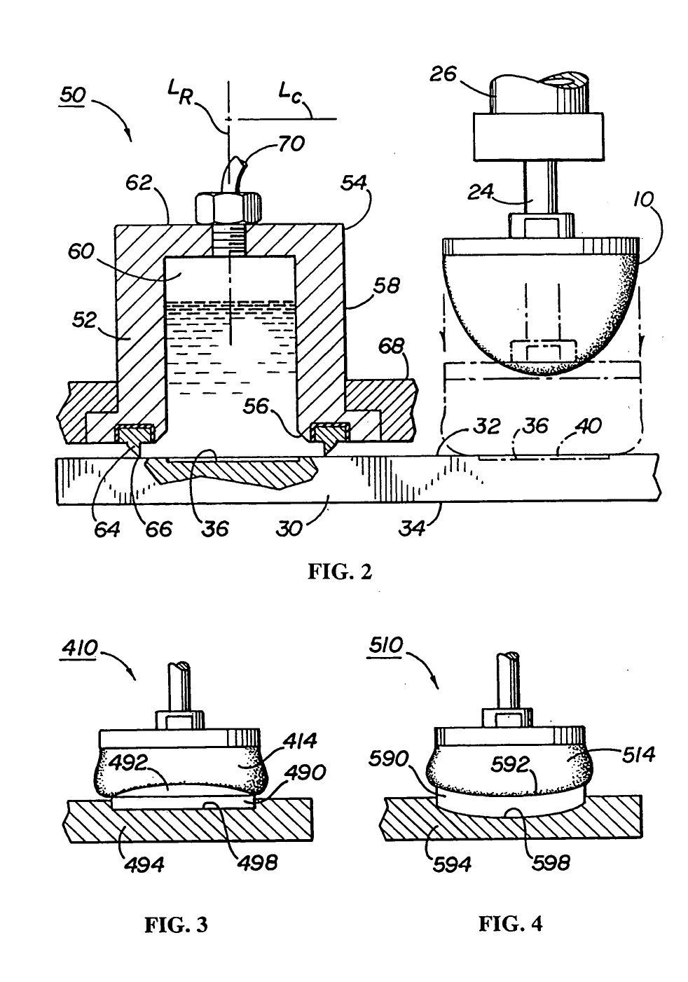

Protective coating solution 40 filling cliche 36 of cliche plate 30 may come from a reservoir that contains the protective coating solution (or a primer solution). As best shown in FIGS. 1 and 2, reservoir 50 has a body 52 with a first end 54 and a second end 56, an outer surface 58 and a longitudinal axis L_{R}. Reservoir 50 defines an axially extending bore 60. A cap 62 closes extending bore 60 at first end 54, and a wiper blade 64 is positioned surrounding extending bore 60 at second end 56. Wiper blade 64 has a blade edge 66, which is sized to encircle cliche 36 when reservoir 50 is positioned over cliche 36 so as to separate bore 60 from the ambient air. In use, when reservoir 50 is positioned with second end 56 against first surface 32 of cliche plate 30, cliche plate 30 cooperates with wiper blade 64 to close extending bore 60 at second end 56 so that protective coating solution 40 is contained therein. A washer 68 may be fitted at second end 56 outside outer surface 58 of body 52. Washer 68 can protect wiper blade 64 including blade edge 66 and may further seal bore 60.

Additionally, reservoir 50 may have an inlet 70 through cap 62. Inlet 70 is in fluid communication with bore 60 and a supply (not shown) of protective coating solution 40. Protective coating solution 40 can be provided to bore 60 of reservoir 50 from the supply of the protective coating solution through inlet 70.

As shown in FIG. 1, optical device 90 with optical surface 92 is positioned on and supported by lens indexing plate 94 such that optical surface 92 is facing away from lens indexing plate 94 and can be contacted by transfer pad 10 having base 12 and deformable body 14. Lens plate indexing cylinder 96 is coupled to lens indexing plate 94. Lens plate indexing cylinder 96 can be utilized to move, control and position lens indexing plate 94 so as to move, control and position optical device 90.

Optionally, a lens indexing plate may have a recess to receive an optical device or other substrate to be coated. For example, as shown in FIG. 3, lens indexing plate 494 may have a recess 498 that is annular and has a flat bottom to receive an optical device 490 having a concave optical surface 492. The optical device 490 is received in recess 498 such that concave optical surface 492 is facing away from lens indexing plate 494 and can be contacted by a transfer pad 410 with deformable body 414. Alternatively, as shown in FIG. 4, lens indexing plate 594 may have a recess 598 that is annular and has a convex bottom to receive optical device 590 having a convex optical surface 592. Optical device 590 is received in recess 598 such that convex optical surface 592 is facing away from lens indexing plate 594 and can be contacted by transfer pad 510 with deformable body 514. Additionally, a lens indexing plate may have several recesses, each being able to receive an optical device. The recesses may be different or the same.

Returning to the operation of apparatus 200 as shown in FIGS. 1, 2 and 5A-5F, reservoir 50 containing protective coating solution 40 is provided and positioned with its second end 56 against first surface 32 of cliche plate 30. Cliche plate 30 cooperates with wiper blade 64 to close extending bore 60 at second end 56. Cliche plate 30 is moved relative to reservoir 50 in direction L_{C}, which is substantially perpendicular to the longitudinal axis L_{R} of reservoir 50, so that blade edge 66 crosses cliche 36 to leave some of protective coating solution 40 in cliche 36. Referring to FIG. 10, the relative motion can be accomplished in at least two ways. The first option is to keep cliche plate 1130 stationary, and move reservoir 1150 in a relative motion to fill the cliche with protective coating solution. Alternatively, the second option is to keep reservoir 1150 stationary, and move cliche plate 1130 in a relative motion to fill the cliche with protective coating solution. Each of these options may be satisfactorily utilized to practice the present invention. In the description below, for definiteness, the second option is chosen. In this embodiment, cliche plate 30 is moved from a retracted position or a first position, which is the position underneath reservoir 50, to a working position or second position, which is the position underneath transfer pad 10. The motion of cliche plate 30 can be controlled by cliche indexing cylinder 80. Now, cliche plate 30 has some protective coating solution 40 in its cliche 36.

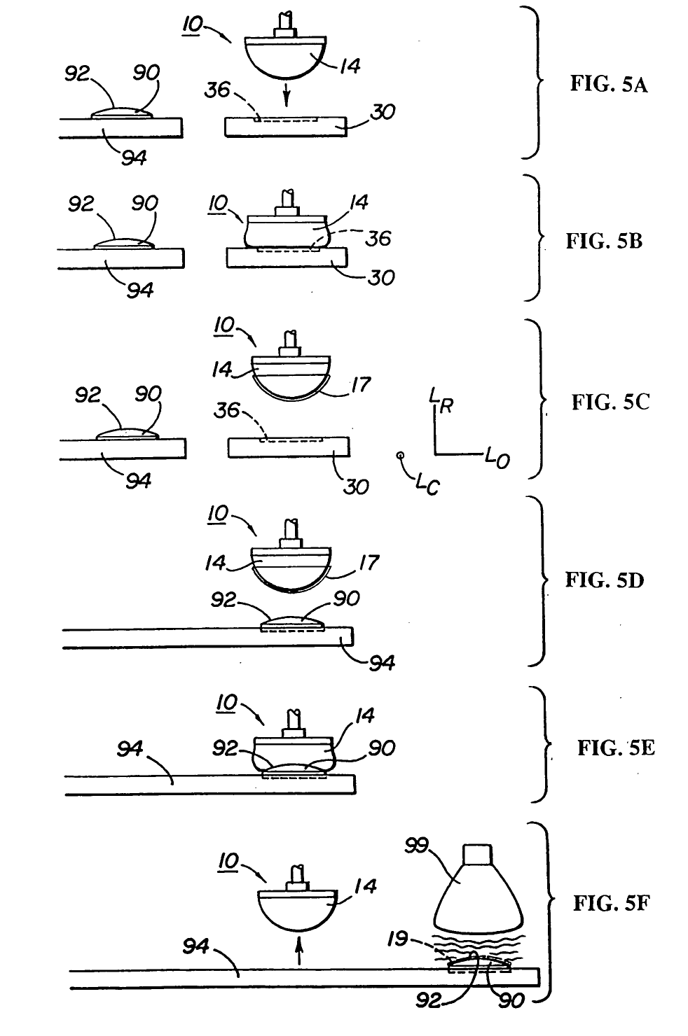

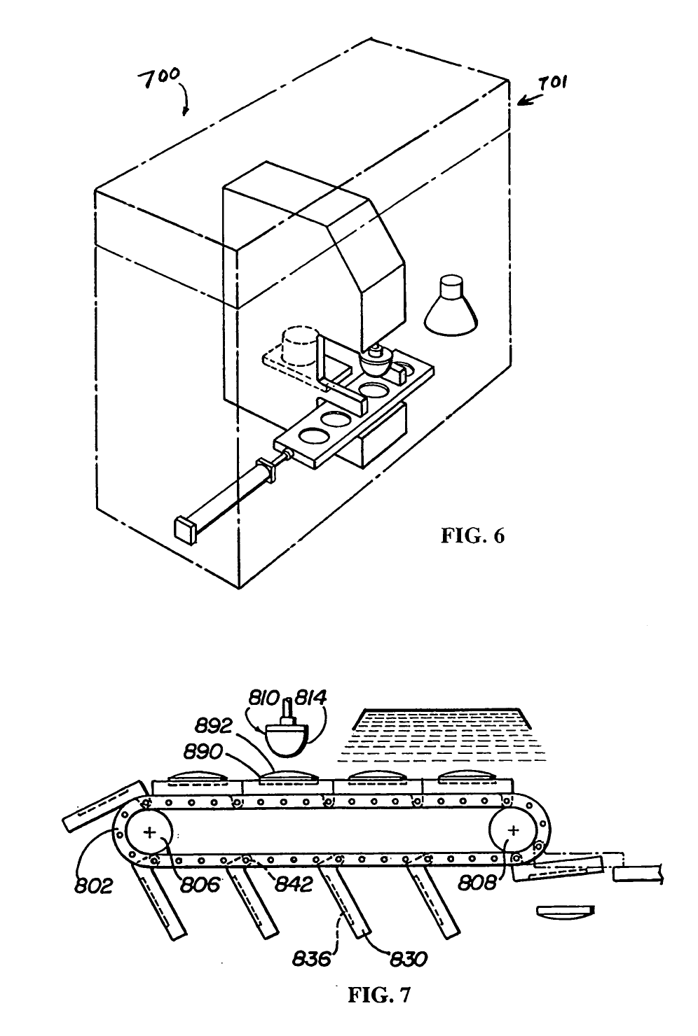

Referring now to FIGS. 5A-5F, once cliche plate 30 having protective coating solution in its cliche 36 is positioned underneath transfer pad 10 and in alignment with transfer pad 10 along the axis L_{R}, transfer pad 10 and cliche plate 30 are brought into contact with one another so that transfer pad 10 contacts the protective coating solution in the cliche 36. As shown in FIG. 2, an optional transfer pad holder 24 may be mechanically coupled to base 12 of transfer pad 10 for handling transfer pad 10. A transfer pad cylinder 26 may be mechanically coupled to transfer pad holder 24. Transfer pad cylinder 26 and transfer pad holder 24 are utilized to move transfer pad 10 along a pathway parallel to direction L_{R}.

In one embodiment as best shown in FIG. 5A, transfer pad 10 moves down from its home position into the second position to contact with cliche plate 30. Transfer pad 10 is pressed against cliche 36 of cliche plate 30 so that deformable body 14 is deformed and some protective coating solution is transferred from cliche 36 to form layer 17 of protective coating solution on surface 20 of deformable body 14 as shown in FIGS. 5B and 5C.

Transfer pad 10 and cliche plate 30 are then separated from each other in a second relative movement so that transfer pad 10 is substantially back to its home position and cliche plate 30 is substantially back to or stays at the second position. In the embodiment as best shown in FIG. 5C, transfer pad 10 moves up to its home position along the axis L_{R}, and cliche plate 30 retracts to its retracted position, which is underneath reservoir 50, from the second position along the axis L_{C}. Geometrically speaking, the second position and the retracted position of cliche plate 30 are aligned along the axis L_{C}, the second position and the home position of transfer pad 10 are aligned along the axis L_{R}, and the axis L_{C} and the axis L_{R} are substantially perpendicular to each other. Thereafter, a protective coating solution can be placed similarly in cliche 36 of cliche plate 30 in the retracted position, and cliche plate 30 having the protective coating solution in cliche 36 may be again positioned in the second position ready for transferring the protective coating solution to a transfer pad again.

Referring now to FIG. 5D, lens indexing plate 94 with optical device 90 moves from its home position along the axis L_{O} into the second position underneath transfer pad 10 that was previously occupied by cliche plate 30 and in alignment with transfer pad 10 along the axis L_{R}. As shown in FIG. 5E, transfer pad 10 and lens indexing plate 94 are brought together in a relative movement so that transfer pad 10 contacts optical device 90 to transfer layer 17 of protective coating solution to optical surface 92. In the embodiment as best shown in FIG. 5E, transfer pad 10 moves down from its home position into the second position to contact with optical surface 92. Transfer pad 10 is pressed against optical surface 92 so that deformable body 14 is deformed and at least some of layer 17 of protective coating solution is transferred from deformable body 14 to form layer 19 of the protective coating solution on optical surface 92 of optical device 90. Transfer pad 10 and lens indexing plate 94 (and hence optical device 90) are then separated from each other in a relative movement so that transfer pad 10 is substantially back to its home position. Lens indexing plate 94 is moved to a third position for curing by radiation energy source 99 as shown in FIG. 5F.

It should be noted that the above description associated with FIGS. 5A-5F provides only one way to apply a protective coating to an optical surface (or any other substrate) accordingly to the present invention. Many alternatives are available. For examples, cliche plate 30 and lens indexing plate 94 may be kept stationary while transfer pad 10 is moved to get the protective coating solution from cliche plate 30 first and then transfer the protective coating solution to optical device 90 positioned on lens indexing plate 94. Cliche plate 30 and lens indexing plate 94 may be kept stationary, independently or jointly. Moreover, these motions may be controlled either manually or automatically.

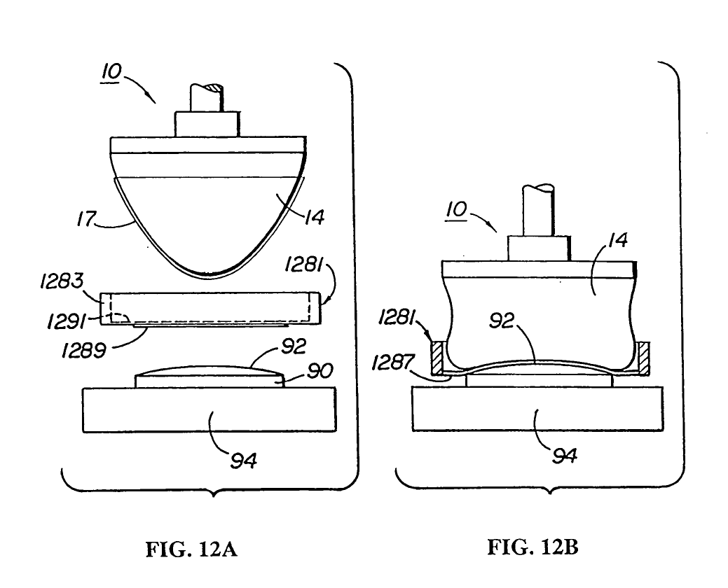

Additionally, as shown in FIGS. 11A-11B and 12A-12B, screen 1281 can be placed over optical surface 92 of optical device 90 (or other substrate) prior to transfer pad 10 being pressed against optical surface 92. In one embodiment, screen 1281 has frame 1283 defining opening 1285, which is covered by film 1287. Film 1287 in one embodiment is a coated fiber that has area 1289 where coating is removed. Area 1289 has a plurality or matrix of holes 1291 to allow protective coating solution to pass through at a controlled rate. The matrix of holes 1291 allows the protective coating solution to percolate through. When transfer pad 10 is pressed against screen 1281, fiber film 1287 curves to fit optical surface 92 under the pressure of deformable body 14 to cause the protective coating solution from transfer pad 10 to screen 1281 to reach optical surface 92 through area 1289, which results in a protective coating layer 19 with a better uniformity as shown in FIG. 13B.

Once layer 19 of protective coating solution is applied to optical surface 92, the protective coating solution associated with optical surface 92 is further treated with proper radiation so as to form a protective coating on optical surface 92. Radiation treatment includes curing. As one skilled in the art will appreciate, curing can be accomplished in a number of ways. For example, the curing method step of the present invention may involve exposing the protective coating solution to an ultraviolet (“UV”) light for a desired time. In addition, prior to exposing the protective coating solution to UV light, the protective coating solution may be heated for a predetermined time, such as in an infra-red (“IR”) oven or via exposure to an IR light. The IR heating step helps “level” the protective coating solution on the substrate prior to being cured with UV light. This can result in a smoother surface, which is optically more desirable.

Thus, in one exemplary embodiment of the present invention, a method for applying a protective coating to a surface of a substrate is provided. In one embodiment, the method includes the steps of placing a protective coating solution in a cliche of a cliche plate, transferring the protective coating solution from the cliche to a transfer pad, pressing the transfer pad to a surface of a substrate so as to transfer at least a portion of the protective coating solution from the transfer pad to the surface, possibly heating the protective coating prior to curing to help level the protective coating, and curing the protective coating layer to form a protective coating on the surface by radiation outside the wavelength range of microwave such as UV, visible and/or IR radiation.

In yet another aspect, the present invention provides a method for applying a protective coating to at least one surface of a substrate, such as an optical mold. In one exemplary embodiment, the method includes the steps of placing a protective coating solution in a cliche of a cliche plate, transferring the protective coating solution from the cliche to a transfer pad, providing a front mold and a back mold each having a facing inside surface, pressing the transfer pad to each of the facing inside surfaces of the front mold and back mold so as to transfer at least a portion of the protective coating solution from the transfer pad to each of the facing inside surfaces, respectively, using a UV “precure process” to slightly polymerize the coating so that it retains its physical placement on the molds, positioning the front mold and the back mold whose facing inside surfaces are a negative image of the surfaces of an optical lens to be formed at a proper distance and rotational orientation relative to each other, both the front mold and back mold having an edge, closing the edges of the front mold and back mold with a closure member to define a molding cavity, injecting a fluid lens-forming material into the molding cavity, and curing the fluid lens-forming material by radiation outside the wavelength range of microwave so that the fluid lens-forming material is hardened to form the optical lens and each of the protective coating layers on the inside surfaces of the front mold and back mold is transferred to and hardened to be bond on a corresponding surface of the optical lens. The closure member can be a gasket, a sleeve, or a wrap.

The whole process of applying a protective coating solution to substrate, such as an optical surface, can be automated. In one exemplary embodiment shown in FIG. 7, a plurality of lens indexing plates 830 are moved along transfer belt 802, which is driven by rollers 806 and 808 associated with transfer belt 802. Each of the plurality of lens indexing plates 830 is positioned along transfer belt 802 through holding means 842 and is loaded with an optical device 890 with an optical surface 892 at area 1. Each optical device 890 is positioned within depression 836 of each indexing plate 830. Protective coating solution is then transferred from deformable body 814 of transfer pad 810 to optical surface 892 by pressing deformable body 814 against optical surface 892 at area 2. At area 3, optical surface 892 with the applied protective coating solution is cured with UV and/or IR radiation. At area 4, optical device 890 with cured protective coating on optical surface 892 is unloaded for further processing. The lens indexing plates 830 may be different or the same, and each of them can be loaded with a different or identical optical device for coating.

Although not shown in FIG. 7, it should be noted that the automated process may also include multiple pad printing steps, wherein one or more primer coatings are first applied to a given substrate, following by one or more drying steps, and then followed by one or more protective coatings applied over the dried primer coating. An automated heating and curing step may be used to dry and cure the final protective coating.

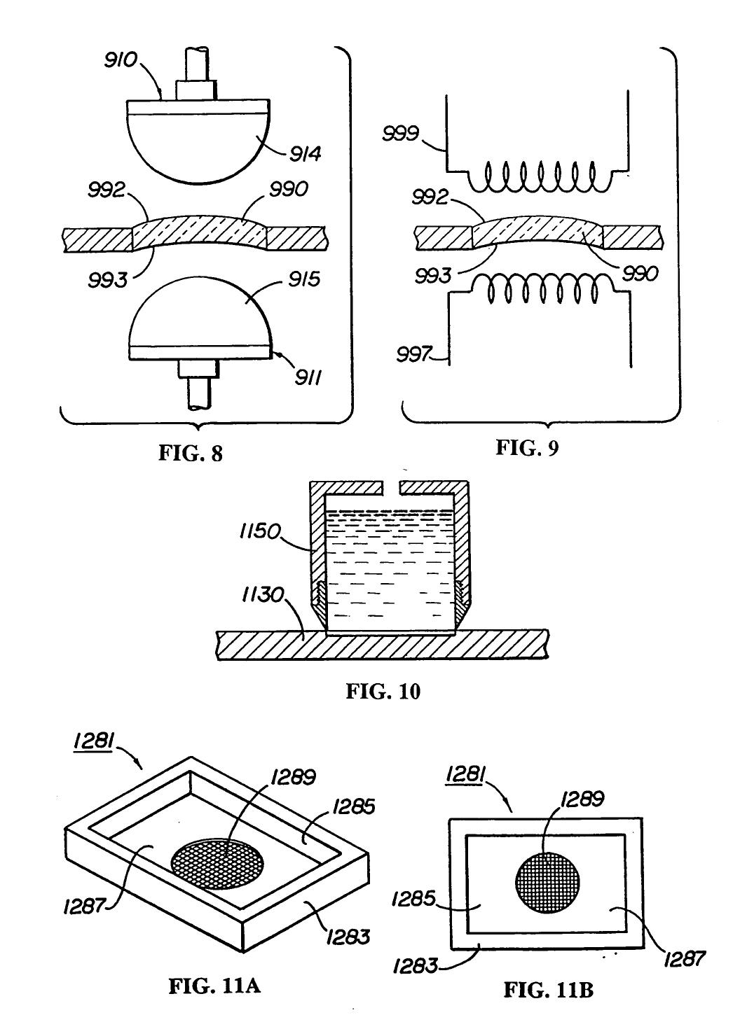

Referring now to FIGS. 8 and 9, methods of the present invention may be utilized to apply protective coating solution to a substrate having two outer surfaces to be coated, such as optical device 990 having two optical surfaces 992 and 993. In one embodiment, protective coating solution is picked up by first transfer pad 910 having deformable body 914 and second transfer pad 911 having deformable body 915. Optical device 990 is positioned between first transfer pad 910 and second transfer pad 911. Then, first transfer pad 910 is pressed against first optical surface 992, and second transfer pad 911 is pressed against second optical surface 993, respectively, so as to transfer the protective coating solutions from first transfer pad 910 and second transfer pad 911 to first optical surface 992 and second optical surface 993 respectively. As shown in FIG. 9, first radiation energy source 999 and second radiation energy source 997 may be utilized to irradiate first optical surface 992, and second optical surface 993 respectively. Each of first radiation energy source 999 and second radiation energy source 997 may include a microwave energy source such as a microwave oven, an infra-red (“IR”) light, an ultra-violet (“UV”) light, other types of energy sources, or any combination thereof.

In a further embodiment of the present invention as shown in FIG. 6, apparatus 200 may be placed in an air filtration system 701 to form an integrated coating station or system. As shown in FIG. 6, an integrated apparatus 700 includes any of the above-described components of apparatus 200. Each of the apparatus components is placed inside air filtration system 701, which includes a properly sealed cabinet that is controlled under a slightly positive atmosphere than that of the surrounding to repel dust and dirt. A computer (not shown) may be utilized to control and coordinate the operation of coating apparatus 700.

As described above, a variety of protective coating solutions may be applied using the above-described method of the present invention. It should be noted that multiple protective coatings may be applied to a given surface of a substrate as needed to result in a protective coating having a desired thickness. The thickness of the protective coating may vary depending on a number of factors including, but not limited to, the substrate, the protective coating composition, and the end use of the coated product. Typically, it is desirable for the coated substrates of the present invention to have a protective coating having a coating thickness of up to about 20 microns (μm). In some embodiments of the present invention, the protective coating has a coating thickness ranging from about 2 microns (μm) to about 10 μm.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLES

The following examples provide a description of exemplary protective coatings of the present invention.

Protective Coating Materials

The materials shown in Table 3 were used in the examples below.

TABLE 3
Materials Used In Examples

| | | |
|---|---|---|
| Material | Description | Manufacturer |

Potential Adhesion Promoters

| | | |
|---|---|---|
| DOWANOL ® | propylene glycol methyl ether | Dow Chemical |
| PMA | acetate | Company |
| | | Midland, MI |
| PROGLYDE ® | dipropylene glycol dimethyl | Dow Chemical |
| DMM | ether | Company |
| | | Midland, MI |
| DOWANOL ® | propylene glycol | Dow Chemical |
| PnP | n-propyl ether | Company |
| | | Midland, MI |
| DOWANOL ® | propylene glycol | Dow Chemical |
| PnB | butyl ether | Company |
| | | Midland, MI |
| DYNASYLAN ® | N-(n-butyl) | Degussa Chemical |
| 1189 | 3- | Midland, MI |
| | aminopropyltrimethoxysilane | |
| DYNASYLAN ® | 3- | Degussa Chemical |
| GLYMO | glycidyloxypropyltrimethoxy | Midland, MI |
| | silane | |
| DYNASYLAN ® | 3-methacryloxypropyl- | Degussa Chemical |
| MEMO | trimethoxysilane | Midland, MI |
| DYNASYLAN ® | 3-mercaptopropyl- | Degussa Chemical |
| MTMO | trimethoxysilane | Midland, MI |
| DYNASYLAN ® | vinyltriethoxysilane | Degussa Chemical |
| VTEO | | Midland, MI |
| IPA | isopropyl alcohol | Sigma-Aldrich |
| | | Chicago, IL |
| acetone | acetone | Sigma-Aldrich |
| | | Chicago, IL |
| benzotriazole | benzotriazole | Sigma-Aldrich |
| | | Chicago, IL |

Polymerizable Monomers

| | | |
|---|---|---|
| DPHPA | dipentaerythritol hydroxy | UCB Chemicals |
| | pentaacrylate | Smyrna, GA |
| TRPGDA | tripropylene glycol diacrylate | UCB Chemicals |
| | | Smyrna, GA |
| EB-8301 | an aliphatic urethane | UCB Chemicals |
| | hexaacrylate | Smyrna, GA |
| BYK 371 | solution of an acrylic | BYK Chemie |
| | functional, polyester | Wallingford, CT |
| | modified | |
| | dimethylpolysiloxane | |
| SA-LH | a silicone acrylate | Lambent |
| | | Fernandina Beach, |
| | | FL |
| SA-1663 | a silicone acrylate | Fibrochem |
| | | Dalton, GA |
| Photoinitiators | | |
| DAROCUR ® 1173 | UV-curable photoinitiator | Merck |
| | | Germany |
| IRGACURE ® 907 | UV-curable photoinitiator | Ciba Geigy |
| | | City, State |
| Additives | | |
| triphenylphosphine | triphenylphosphine | Sigma-Aldrich |
| | | Chicago, IL |
| benzophenone | benzophenone | Sigma-Aldrich |
| | | Chicago, IL |
| Substrates | | |
| PMMA sheet | polymethylmethacrylate | Rohm & Haas |
| | | City, STATE |
| LUCITE ® sheet | acrylic | Sigma-Aldrich |
| | | Chicago, IL |
| In-house | polycarbonate sheet | TRI |
| polycarbonate sheet | | Alpharetta, GA |
| LEXAN ® | polycarbonate sheet | General Electric |
| polycarbonate sheet | | Schenectady, NY |
| PET | polyethylene terephthalate | DuPont Chemical |
| | | Company |
| | | Wilmington, DE |

### Example 1

Evaluation of Potential Adhesion Promoters

A variety of potential adhesion promoters were evaluated on a variety of plastics. The following potential adhesion promoters were used on selected plastic surfaces in conjunction with a hard coat base formulation: IPA (isopropyl alcohol), acetone, DOWANOL® PMA (1-methoxy-2-propanol acetate), DOWANOL® PnP (propylene glycol propyl ether), DOWANOL® PnB (propylene glycol butyl ether), and DOWANOL® DMM (dipropylene glycol dimethyl ether).

Table 4 below provides results of five different types of plastics tested with the potential adhesion promoters.

TABLE 4
Select Potential Adhesion Promoters Applied To Select Clear
Plastic Substrates

| | Substrate Tested | | | | |
|---|---|---|---|---|---|
| Potential | | | In-house | | |
| Adhesion | PMMA | LUCITE ® | Polycarbonate | LEXAN ® | PET |
| Promoter | sheet | sheet | sheet | sheet | sheet |
| IPA | no | no attack | no attack | no attack | no |
| | attack | | | | attack |
| Acetone | attacked; | Acetone | attacked; PC | slight | attacked; |
| | PMMA | beaded up | had rainbow | attack; | PET |
| | sheet | on | colors | LEXAN ® | turned |
| | turned | LUCITE ® | | sheet was | cloudy |
| | white | sheet | | still clear | |
| DOWANOL ® | attacked; | PMA | attacked; PC | turned | turned |
| PMA | PMMA | beaded up | turned white | opaque | cloudy |
| | sheet | on | | white | |
| | was still | LUCITE ® | | | |
| | glossy | sheet | | | |
| DOWANOL ® | no | PnP beaded | no attack | no attack | no |
| PnP | attack | up on | | | attack |
| | | LUCITE ® | | | |
| | | sheet; no | | | |
| | | attack | | | |
| DOWANOL ® | no | PnB beaded | no attack | no attack | no |
| PnB | attack | up on | | | attack |
| | | LUCITE ® | | | |
| | | sheet; no | | | |
| | | attack | | | |
| DOWANOL ® | PMMA | DMM | slight attack; | turned | turned |
| DMM | sheet | beaded up | PC was still | cloudy | cloudy |
| | was still | on | glossy | white | |
| | glossy | LUCITE ® | | | |
| | | sheet | | | |

As shown in Table 4, some of the potential adhesion promoters did not attack some of the tested plastic substrates. It is believed that an adhesion promoter that does not attack a given tested plastic substrate is generally not thought to be a suitable adhesion promoter for the given plastic substrate. If the adhesion promoter made the plastic substrate opaque/crazed/cracked, then the adhesion promoter was considered to have some use for the product, but only if used in relatively small quantities.

Referring to Table 4, isopropyl alcohol did not attack either polycarbonate or PMMA, and thus appears to be less useful for these tested plastic substrates. The acetone clouded up polycarbonate very badly, and turned PMMA white. PMA attacked polycarbonate and turned the sheet cloudy. PMA attacked PMMA, but did not turn the PMMA sheet cloudy. DOWANOL® DMM (propylene glycol methyl ether acetate) attacked the surface of PMMA and polycarbonate, yet did not cloud up the surfaces of these plastic substrates.

The exemplary results of Table 4 suggest that different adhesion promoters may be useful depending on the type of plastic substrate being coated. For example, a protective coating for polycarbonate might use a typical hard coat base with an adhesion promoter that slightly attacks or “roughens” the polycarbonate surface. Moreover, each different type of plastic and/or different type of application might use a different type of adhesion promoter and/or amount of adhesion promoter.

### Example 2

Preparation of Protective Coatings Formed from a Separate Base Coat and a Separate Adhesion Promoter

A protective coating of the present invention was prepared by forming a hard coat base solution as shown in Table 1 above. Each of the hard coat components were mixed in a mixing vessel at room temperature. The resulting mixture was stored in a light-proof container for future use.

A first protective coating solution (FPCS2) was prepared by adding 10 pbw of DOWANOL® PMA to the base formulation. A second protective coating (SPCS2) was also prepared by adding 20 pbw of DOWANOL® PMA to the base formulation.

### Example 3

Preparation of Protective Coatings By Combining Base Hard Coat Components and Adhesion Promoters

Four separate protective coatings (i.e., PCS1 to PCS4) were prepared by combining the components as shown in Table 2 above. Each of the components were mixed in a mixing vessel at room temperature. The resulting protective coatings were stored in a light-proof container for future use.

### Example 4

Application of Protective Coatings to PMMA Substrates

The four separate protective coatings (i.e., PCS1 to PCS4) prepared in Example 3 were applied to PMMA substrates to test for adhesion to PMMA substrates. The protective coatings were applied to the PMMA substrates via a drawdown method step. The drawdown method was performed by dropping a small puddle of coating onto the substrate, and then, using a wire-wrapped metal bar (available through Gardner in Pompano Beach, Fla.), evenly applying a layer of coating across the substrate by dragging the metal bar across the coating. Alternatively, a painting step was used to apply the coating. The coating application step was followed by an IR drying step and a UV curing step.

Table 5 below provides adhesion results. Adhesion of a given protective coating to a given substrate was determined using a standard Cross-Hatch Adhesion Test as known in the art. In the Cross-Hatch Adhesion Test, a desired amount of coating is applied to a substrate surface. A sawtooth blade if passed across the coating in a first direction, and then in a second direction, wherein the second direction is perpendicular to the first direction. A grid of 100 squares are formed (i.e., a 10×10 grid). A tape is applied to the 10×10 grid, and pressure is applied. The tape is removed. The number of squares removed are divided by 100, the number of original squares, to determine a percent loss. For example, removal of 30 squares would indicate a 30% loss adhesion value. Consequently, an adhesion result of “0% loss” refers to a strong adhesion, while “100% loss” refers to a weak adhesion.

TABLE 5
Adhesion Results

| | Application | | |
|---|---|---|---|
| Formula | Method | IR Drying Time | Adhesion Degree |
| PSC1 | drawdown | 1 minute | 100% loss |
| PSC1 | drawdown | 2 minutes | 0% loss |
| PSC1 | drawdown | 3 minutes | 10% loss |
| | | | (only on thick edges) |
| PSC2 | drawdown | 1 minute | 100% loss |
| PSC2 | drawdown | 2 minutes | 2% loss |
| PSC3 | foam urethane | 2 minutes | 100% loss |
| | paint brush | | |
| PSC3 | foam urethane | 3 minutes | 0% loss |
| | paint brush | | |
| PSC3 | foam urethane | 4 minutes* | 80% loss |
| | paint brush | (*PMMA warped) | |
| PSC4 | foam urethane | 2 minutes | 0% loss |
| | paint brush | | |
| PSC4 | foam urethane | 3 minutes | 0% loss |
| | paint brush | | |
| PSC4 | foam urethane | 20 minutes | 100% loss |
| | paint brush | air dry | |

As shown in Table 5, the degree of adhesion varies depending on the protective coating solution used, as well as, the dry time and temperature used.

### Example 5

Application of Protective Coatings Using a Pad Printing Process for Scratch-Resistance

A round area of protective coating (FPCS2 from Example 2) was pad coated onto a piece of PMMA sheeting with a circular printing pad, IR dried for 2 minutes, then UV cured for 5 minutes under a nitrogen blanket. The resulting anti-scratch protective coating was subjected to abrasion using a piece of steel wool. The steel wool was dragged across the entire surface of the PMMA sheeting including coated and uncoated areas. The steel wool only scratched the uncoated areas. When the steel wool was used in an attempt to damage the protected surface of the PMMA sheeting (i.e., the protective coating area), the circular surface area treated with the protective coating of the present invention remained unblemished as if the steel wool had never contacted it.

### Example 6

Application of Protective Coatings Using a Pad Printing Process to Repair a Damaged Surface of a Substrate

A piece of Plexiglas was scratched in a checkerboard pattern with a piece of “000” steel wool before any hard coating of the present invention was applied. Then, an amount of PCS 1 was brushed over the scratched area. The scratch marks disappeared immediately. The PCS 1 coating was then dried for 2 minutes under an IR lamp and cured via UV light with a nitrogen blanket for 5 minutes. After completing the curing process, the original scratch marks were virtually invisible, and the PCS 1 coating had good adhesion and good scratch resistance. The resulting protective coating caused the original scratches to be virtually invisible, and also left the treated area with a coating to protect against future damage.

### Example 7

Application of Protective Coatings Using a Pad Printing Process to Surfaces of Plastic Substrates

A protective coating formulation was prepared using the components as shown in Table 6 below.

TABLE 6
Exemplary Protective Coating Composition

| | Parts By | |
|---|---|---|
| Component | Weight | Actual Weight |
| DOWANOL ® PMA | 10.0 | 40.0 g |
| BYK 371 | 2.5 | 10.0 g |
| IRGACURE ® 907 | 2.5 | 10.0 g |
| triphenylphosphine | 0.5 | 2.0 g |
| benzophenone | 0.5 | 2.0 g |
| TRPGDA | 5.0 | 20.0 g |
| EB-8301 | 20.0 | 80.0 g |
| DPHPA | 20.0 | 80.0 g |
| SA-LH | 0.75 | 3.0 g |
| | | 245.0 g |

The protective coating formulation was pad coated onto the following substrates: a polycarbonate sheet, a PMMA sheet, and a PET sheet. Prior to coating each of the substrates, each substrate was (i) washed with an aqueous solution of neutral pH soap, (ii) rinsed with deionized water, (iii) and blown dry. If applicable, the dried substrates were stored in a clean, dry enclosed container prior to coating. Immediately prior to coating, each substrate was blown to remove any dust/dirt using an anti-static air gun.

An apparatus similar to the apparatus shown in FIGS. 1-5F was used to apply a protective coating having a coating thickness of about 2 to 10 microns using a circular printing pad. The coating was dried using an IR oven at 82.2° C. (180° F.) for 2 minutes, and then UV cured for about 5 minutes under a nitrogen blanket.

The resulting protective coating provided the following properties to the coated substrate: scratch resistance and chemical resistance.

### Example 8

Application of Protective Coatings Using a Pad Printing Process to Surfaces of Aluminum Substrates

The protective coating formulation of Example 7 was pad coated onto the following substrates: a 2000 series aluminum sheet, a 3000 series aluminum sheet, a 5000 series aluminum sheet, and a 6000 series aluminum sheet. Prior to coating each of the aluminum substrates, each substrate was (i) washed with an aqueous solution of neutral pH soap, (ii) rinsed with deionized water, (iii) and then blown dry. The substrate was soaked in a 1 wt % solution of HCL for from 1 to 10 minutes.

An apparatus similar to the apparatus shown in FIGS. 1-5F was used to apply a protective coating having a coating thickness of about 2 to 10 microns using a circular printing pad. The coating was dried using an IR oven at 82.2° C. (180° F.) for 2 minutes, and then UV cured for about 5 minutes under a nitrogen blanket.

The resulting protective coating provided the following properties to the coated substrate: scratch resistance, chemical resistance, resistance against tarnishing, and maintenance of the original color of the substrate.

### Example 9

Application of Protective Coatings Using a Pad Printing Process to Surfaces of Aluminum Substrates

A protective coating formulation, PCS128-5, was prepared using the components as shown in Table 7 below.

TABLE 7
Exemplary Protective Coating Composition PCS128-5

| | Parts By | |
|---|---|---|
| Component | Weight | Actual Weight |
| DOWANOL ® PMA | 5.0 | 50.0 g |
| BYK 371 | 2.5 | 25.0 g |
| IRGACURE ® 907 | 0.8 | 8.0 g |
| DAROCUR ® 1173 | 1.7 | 17.0 g |
| triphenylphosphine | 0.5 | 5.0 g |
| benzophenone | 0.5 | 5.0 g |
| TRPGDA | 5.0 | 50.0 g |
| EB-8301 | 20.0 | 200.0 g |
| DPHPA | 20.0 | 200.0 g |
| SA-1663 | 0.5 | 5.0 g |
| | | 565.0 g |

The protective coating formulation PCS128-5 was used to form a number of additional protective coatings as shown in Table 8 below.

TABLE 8
Exemplary Protective Coating Compositions

| | | Additional | Parts |
|---|---|---|---|
| | | Adhesion | By Weight |
| Protective Coating | Actual Weight | Promoter | of Additional |
| Composition | PCS128-5 | Component | Component |
| PCS149-1 | 50 g | DYNASYLAN ® | 1.0 g |
| | | 1189 | |
| PCS149-2 | 50 g | DYNASYLAN ® | 1.0 g |
| | | GLYMO | |
| PCS149-3 | 50 g | DYNASYLAN ® | 1.0 g |
| | | MEMO | |
| PCS149-4 | 50 g | DYNASYLAN ® | 1.0 g |
| | | MTMO | |
| PCS149-5 | 50 g | DYNASYLAN ® | 1.0 g |
| | | VTEO | |

The five protective coatings shown in Table 8 were pad coated onto aluminum 3000 parts using the apparatus and procedure as outlined in Example 8. A first set of aluminum 3000 parts were cleaned using the following procedure: (i) washed with an aqueous solution of neutral pH soap and scrubbed with a 0000 steel wool 10 material, (ii) rinsed with deionized water, (iii) and blown dry. A second set of aluminum 3000 parts was not cleaned using the above procedure.

The five protective coatings shown in Table 8 exhibited good adhesion to each of the parts within the first set of aluminum 3000 parts; however, the five protective coatings shown in Table 8 exhibited poor adhesion to each of the parts within the second set of aluminum 3000 parts.

Of the five protective coatings shown in Table 8, PCS149-2 and PCS149-3 exhibited the best adhesion. Additional protective coatings were prepared as shown in Table 9 below using increased amounts of the DYNASYLAN® adhesion promoters.

TABLE 9
Exemplary Protective Coating Compositions

| Protective | | | Parts By Weight |
|---|---|---|---|
| Coating | Actual Weight | Additional | of Additional |
| Composition | PCS128-5 | Component | Component |
| PCS153-1 | 50 g | DYNASYLAN ® | 2.5 g |
| | | GLYMO | |
| PCS153-2 | 50 g | DYNASYLAN ® | 2.5 g |
| | | MEMO | |

The protective coatings shown in Table 10 exhibited good adhesion to each of the parts within the first set of aluminum 3000 parts.

A third set of aluminum 3000 parts were washed in a TSP (trisodium phosphate) solution to remove any dust/dirt/oils, and then soaked in a 1 wt % HCL solution for about 1 to 10 minutes. All of the protective coatings shown in Tables 8-10 exhibited excellent adhesion to each of the aluminum 3000 parts in the third set of parts. Using the TSP/HCL wash procedure prior to pad coating minimized the need to add additional adhesion promoters (e.g., the DYNASYLAN® adhesion promoters) into the protective coating composition.

### Example 10

Adhesion of Protective Coatings to Surfaces of Aluminum Substrates

The adhesion of a number of protective coatings was analyzed using the following components and cleaning procedures outlined in Table 10 below. PCS152-2 had the same formula as PCS128-5 shown in Table 7 above except that PCS152-2 contains an equal amount of SA-LH instead of SA-1663 in PCS128-5.

TABLE 10
Adhesion of Exemplary Protective Coating Compositions
To Aluminum 3000 Dishes

| Protective | Additional | | |
|---|---|---|---|
| Coating | Adhesion | | Percent |
| Composition | Promoter | Cleaning Procedure | Adhesion |
| PCS152-2 | none | none | 0% |
| PCS152-2 | none | 1 hour TSP soak | 10% |
| PCS149-1 | 2 wt % | none | 15% |
| | DYNASYLAN ® | | |
| | 189 | | |
| PCS149-1 | 2 wt % | 1 hour TSP soak | 60% |
| | DYNASYLAN ® | | |
| | 189 | | |
| PCS149-2 | 2 wt % | none | 0% |
| | DYNASYLAN ® | | |
| | GLYMO | | |
| PCS149-2 | 2 wt % | 1 hour TSP soak | 80% |
| | DYNASYLAN ® | | |
| | GLYMO | | |
| PCS149-3 | 2 wt % | none | 9% |
| | DYNASYLAN ® | | |
| | MEMO | | |
| PCS149-3 | 2 wt % | 1 hour TSP soak | 90% |
| | DYNASYLAN ® | | |
| | MEMO | | |
| PCS149-4 | 2 wt % | none | 5% |
| | DYNASYLAN ® | | |
| | MTMO | | |
| PCS149-4 | 2 wt % | 1 hour TSP soak | 60% |
| | DYNASYLAN ® | | |
| | MTMO | | |
| PCS152-2 | none | none | 0% |
| PCS152-2 | none | 1 hour TSP soak | 18% |
| PCS152-2 | none | 18 hour TSP soak | 28% |
| PCS152-2 | none | 1 hour TSP soak plus | 80% |
| | | 10 minute 1 wt % HCL | |
| | | soak | |
| PCS152-2 | none | 1 hour TSP soak plus 1 | 98% |
| | | hour 1 wt % HCL soak | |
| PCS153-1 | 5 wt % | none | 0% |
| | DYNASYLAN ® | | |
| | GLYMO | | |
| PCS153-1 | 5 wt % | 1 hour TSP soak | 14% |
| | DYNASYLAN ® | | |
| | GLYMO | | |
| PCS153-1 | 5 wt % | 18 hour TSP soak | 23% |
| | DYNASYLAN ® | | |
| | GLYMO | | |
| PCS153-1 | 5 wt % | 1 hour TSP soak plus | 80% |
| | DYNASYLAN ® | 10 minute 1 wt % HCL | |
| | GLYMO | soak | |
| PCS153-1 | 5 wt % | 1 hour TSP soak plus 1 | 100% |
| | DYNASYLAN ® | hour 1 wt % HCL soak | |
| | GLYMO | | |
| PCS153-1 | 5 wt % | none | 0% |
| | DYNASYLAN ® | | |
| | MEMO | | |
| PCS153-1 | 5 wt % | 1 hour TSP soak | 15% |
| | DYNASYLAN ® | | |
| | MEMO | | |
| PCS153-1 | 5 wt % | 18 hour TSP soak | 50% |
| | DYNASYLAN ® | | |
| | MEMO | | |
| PCS153-1 | 5 wt % | 1 hour TSP soak plus | 85% |
| | DYNASYLAN ® | 10 minute 1 wt % HCL | |
| | MEMO | soak | |
| PCS153-1 | 5 wt % | 1 hour TSP soak plus 1 | not tested |
| | DYNASYLAN ® | hour 1 wt % HCL soak | |
| | MEMO | | |

The protective coatings were pad coated onto aluminum 3000 dishes using the apparatus and procedure as outlined in Example 8. The percent adhesion was measured using the Cross-Hatch Adhesion Test method described above.

Adhesion of protective coatings was improved by a TSP soak, further improved by a longer TSP soak, even further improved with a TSP soak in combination with a 1 wt % HCL soak, and even further improved with a longer TSP soak in combination with a longer 1 wt % HCL soak.

### Example 11

Application of Protective Coatings Using a Pad Printing Process to Ion Vapor Deposited Aluminum Parts

Ion vapor deposited (IVD) aluminum-coated polycarbonate parts were coated with protective coatings of the present invention. Prior to coating the IVD aluminum-coated polycarbonate parts, each part was (i) washed with an aqueous solution of a mild detergent, (ii) rinsed with deionized water, (iii) and then blown dry using compressed air. If applicable, the dried substrates were stored in a clean, dry enclosed container prior to coating to prevent contamination from dust.

Primer coatings were applied to the cleaned parts. The primer coating compositions are shown in Tables 11 and 12 below.

TABLE 11
Exemplary Primer Coating Composition PCC171-1

| | Parts By | |
|---|---|---|
| Component | Weight | Actual Weight |
| isopropyl alcohol | 87.8 | 87.8 g |
| deionized water | 10.0 | 10.0 g |
| DYNASYLAN ® GLYCO | 2.0 | 2.0 g |
| glacial acetic acid | 0.2 | 0.2 g |

TABLE 12
Exemplary Primer Coating Composition PCC171-2

| Component | Parts By Weight | Actual Weight | |
|---|---|---|---|
| isopropyl alcohol | 87.8 | 87.8 | g |
| deionized water | 10.0 | 10.0 | g |
| DYNASYLAN ® MEMO | 2.0 | 2.0 | g |
| glacial acetic acid | 0.2 | 0.2 | g |

After the primer coating was applied, the primer coating was dried using an IR light, although any other heat source could be used.

An apparatus similar to the apparatus shown in FIGS. 1-5F was used to apply a protective coating having the components as shown in Table 13 below.

TABLE 13
Exemplary Protective Coating Composition PCS40-1

| Component | Parts By Weight | Actual Weight | |
|---|---|---|---|
| DOWANOL ® PMA | 5.0 | 20.0 | g |
| BYK 371 | 2.5 | 10.0 | g |
| IRGACURE ® 907 | 2.5 | 10.0 | g |
| triphenylphoshine | 0.5 | 2.0 | g |
| benzophenone | 0.5 | 2.0 | g |
| TRPGDA | 5.0 | 20.0 | g |
| EB-8301 | 20.0 | 80.0 | g |
| DPHPA | 20.0 | 80.0 | g |
| SA-LH | 0.75 | 3.0 | g |
| | | 225.0 | g |

The coating was dried using an IR oven at 82.2° C. (180° F.) for 2 minutes, and then UV cured for about 5 minutes under a nitrogen blanket. The protective coating had a coating thickness of about 2 to 10 microns using a circular printing pad.

### Example 12

Application of Protective Coatings Using a Pad Printing Process to Ion Vapor Deposited Aluminum Parts

IVD aluminum-coated polycarbonate parts were coated with protective coatings of the present invention using the procedure as outlined in Example 11 except the following primer coating compositions were used as shown in Tables 14 and 15 below.

TABLE 14
Exemplary Primer Coating Composition PCC179-1

| Component | Parts By Weight | Actual Weight | |
|---|---|---|---|
| isopropyl alcohol | 78.0 | 78.0 | g |
| deionized water | 10.0 | 10.0 | g |
| DYNASYLAN ® MEMO | 10.0 | 10.0 | g |
| glacial acetic acid | 2.0 | 2.0 | g |

TABLE 15
Exemplary Primer Coating Composition PCC179-2

| Component | Parts By Weight | Actual Weight |
|---|---|---|
| isopropyl alcohol | 70.0 | 70.0 g |
| deionized water | 10.0 | 10.0 g |
| DYNASYLAN ® MEMO | 10.0 | 10.0 g |
| phosphoric acid | 10.0 | 10.0 g |

Some of the IVD aluminum-coated polycarbonate parts were subjected to a TSP pre-clean (i.e., a 30 second wash with hand rubbing, followed by rinsing with tap water), and a corona discharge treatment prior to soaking in a primer solution.

Adhesion of a number of protective coatings to IVD aluminum-coated polycarbonate parts was analyzed using the following primer components and cleaning procedures outlined in Table 16 below.

TABLE 16
Adhesion of Exemplary Protective Coating Compositions
To IVD Aluminum-Coated Polycarbonate Parts

| | | | | Protective | |
|---|---|---|---|---|---|
| Part | Corona | Primer | Soak Time | Coating | Percent |
| No. | Discharge | Solution | (minutes) | Composition | Adhesion |
| 1 | yes | none | none | PCS152-2 | 0% |
| 2 | yes | PCC171-2 | 20 | PCS152-2 | 1% |
| 3 | yes | PCC179-1 | 20 | PCS152-2 | 10% |
| 4 | yes | PCC179-2 | 20 | PCS152-2 | 2% |
| 5 | no | PCC171-2 | 20 | PCS152-2 | 96% |
| 6 | no | PCC179-1 | 20 | PCS152-2 | 6% |
| 7 | no | PCC179-2 | 20 | PCS152-2 | 100% |

### Example 13

Application of Protective Coatings Using A Pad Printing Process to Ion Vapor Deposited Aluminum Parts

IVD aluminum-coated polycarbonate parts were coated with protective coatings of the present invention using the procedure as outlined in Example 11 except the primer coating compositions were applied using techniques to prevent excess coating thickness of the primer solutions. One technique was positioning the IVD aluminum-coated polycarbonate part at a 60° angle to a tabletop, and flooding the surface of the part with primer solution so that excess primer solution could run off the part onto the tabletop. In an alternative technique, a primer solution was sprayed onto the part. The primer coatings were dried for 4 minutes at a temperature of 180° F. Using either technique, primer coatings having a coating thickness of from about 5 to 10 μm were obtained.

An apparatus similar to the apparatus shown in FIGS. 1-5F was used to apply protective coating PCS152-2 having a coating thickness of about 2 to 10 μm using a circular printing pad. The coating was dried using an IR oven for 4 minutes at 82.2° C. (180° F.), and then UV cured for about 4 minutes under a nitrogen blanket. The resulting protective coatings exhibited excellent scratch resistance, as well as, 95% adhesion.

### Example 14

Application of Protective Coatings Using a Pad Printing Process to Surfaces of Yellow Metal Substrates

A protective coating formulation as shown in Table 17 below was applied to the following yellow metals: brass, bronze and copper.

TABLE 17
Exemplary Protective Coating Composition PCS40-1

| Component | Parts By Weight | Actual Weight | |
|---|---|---|---|
| DOWANOL ® PMA | 5.0 | 20.0 | g |
| benzotriazole | 1.0 | 4.0 | g |
| BYK 371 | 2.5 | 10.0 | g |
| IRGACURE ® 907 | 2.5 | 10.0 | g |
| triphenylphosphine | 0.5 | 2.0 | g |
| benzophenone | 0.5 | 2.0 | g |
| TRPGDA | 5.0 | 20.0 | g |
| EB-8301 | 20.0 | 80.0 | g |
| DPHPA | 20.0 | 80.0 | g |
| SA-LH | 0.75 | 3.0 | g |
| | | 231.0 | g |

Prior to coating each of the metal substrates, each substrate was (i) washed with an aqueous solution of neutral pH soap, (ii) rinsed with deionized water, and (iii) scrubbed with 400 grit sandpaper in combination with a 3 wt % solution of phosphoric acid. The substrates were then soaked in a 1 wt % solution of HCL for about 1 minute at room temperature, and removed from the acidic solution, rinsed with deionized water, and dried using a compressed air gun.

An apparatus similar to the apparatus shown in FIGS. 1-5F was used to apply a protective coating having a coating thickness of about 2 to 10 microns using a circular printing pad. The coating was dried using an IR oven for 5 minutes at 82.2° C. (180° F.), and then UV cured for about 4 minutes under a nitrogen blanket.

The resulting protective coatings exhibited 100% adhesion to the metal substrates. The resulting protective coatings provided the following properties to the coated yellow metal substrates: scratch resistance, chemical resistance, resistance against tarnishing/oxidation, and maintenance of the original color of the substrate.

The coated yellow metal substrates were placed outdoors. After one hour of outdoor exposure including some rain, the coated areas remained completely free of oxidation, while uncoated areas were already quite oxidized. After 11 days of outdoor exposure, the coated areas remained completely free of oxidation.

### Example 15

Application of Protective Coatings Using a Pad Printing Process to Surfaces of Yellow Metal Substrates

A primer coating formulation as shown in Table 16 was applied to the following yellow metals: brass, bronze and copper. Prior to coating each of the metal substrates, each substrate was (i) washed with an aqueous solution of neutral pH soap, (ii) rinsed with deionized water, and (iii) scrubbed with 400 grit sandpaper in combination with a 3 wt % solution of phosphoric acid. The substrates were then soaked in a 1 wt % solution of HCl for about 1 minute at room temperature, and removed from the acidic solution, rinsed with deionized water, and dried using a compressed air gun.

The coated yellow metal substrates were placed outdoors. After 11 days of outdoor exposure, the coated areas remained completely free of oxidation. In addition, the primer coating helped maintain the original color of the copper substrates.

### Example 16

Application of Protective Coatings Using a Pad Printing Process to Surfaces of Yellow Metal Substrates

Protective coatings and optional primer coatings were applied to the copper metal parts. The protective coating had a composition as shown in Table 18 below.

TABLE 18
Exemplary Protective Coating Composition PCS4-3

| Component | Parts By Weight | Actual Weight | |
|---|---|---|---|
| DOWANOL ® PMA | 5.0 | 20.0 | g |
| benzotriazole | 1.0 | 4.0 | g |
| BYK 371 | 2.5 | 10.0 | g |
| IRGACURE ® 907 | 2.5 | 10.0 | g |
| triphenylphosphine | 0.5 | 2.0 | g |
| benzophenone | 0.5 | 2.0 | g |
| TRPGDA | 10.0 | 40.0 | g |
| EB-8301 | 17.5 | 70.0 | g |
| DPHPA | 17.5 | 70.0 | g |
| SA-LH | 0.75 | 3.0 | g |
| | | 231.0 | g |

Prior to coating each of the copper metal parts, each part was (i) washed with an aqueous solution of neutral pH soap, (ii) rinsed with deionized water, and (iii) soaked in a 1N HCL solution, and removed from the acidic solution, rinsed with deionized water, and dried using a compressed air gun. Adhesion results are shown in Table 19 below.

TABLE 19
Adhesion of Exemplary Protective Coating Compositions
To Copper Metal Parts

| Part | Acid Soak | | | Percent |
|---|---|---|---|---|
| No. | Time | Acid Soak Temp. | Primer Used | Adhesion |
| 1 | 1 minute | 21.1° C. (70° F.) | none | 0% |
| 2 | 1 minute | 48.9° C. (120° F.) | none | 80% |
| 3 | 1 minute | 21.1° C. (70° F.) | PCC171-2 | 50% |
| 4 | 1 minute | 48.9° C. (120° F.) | PCC171-2 | 80% |
| 5 | 3 minutes | 21.1° C. (70° F.) | none | 95% |
| 6 | 3 minutes | 48.9° C. (120° F.) | none | 50% |
| 7 | 3 minutes | 21.1° C. (70° F.) | PCC171-2 | 80% |
| 8 | 3 minutes | 48.9° C. (120° F.) | PCC171-2 | 90% |

The coated yellow metal substrates were placed outdoors. After 11 days of outdoor exposure, the coated areas remained completely free of oxidation.

### Example 17

Application of Protective Coatings Using a Pad Printing Process to Glass Substrates

Four glass substrates were coated with protective coatings of the present invention using the procedure as outlined in Example 11. The primer coating compositions shown in Tables 15 and 16 were applied to the glass substrates. Protective coating formulation, PCS128-5, shown in Table 7 was applied to two of the coated substrates.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A method of providing a protective coating to a substrate, said method comprising the steps of:
pad printing a curable protective coating onto a substrate, wherein the curable protective coating comprises at least one adhesion promoter selected from the group consisting of glycol ethers, glycol ether acetates, benzotriazole, a silane, and combinations thereof.

2. The method of claim 1, further comprising the step of:
exposing the curable protective coating to sufficient radiation to form a cured protective coating.

3. The method of claim 2, wherein the radiation is generated by an infrared (IR) light source, an ultraviolet (UV) light source, or a combination thereof.

4. The method of claim 1, further comprising the step of:
pre-treating a surface to be coated on the substrate, wherein the step of pre-treating comprises one or more of the following steps:
(i) contacting the surface with an aqueous pH neutral soap solution;
(ii) contacting the surface with a trisodium phosphate (TSP) solution;
(iii) contacting the surface with an aqueous acidic solution;
(iv) contacting the surface with a rinse of deionized water;
(v) drying the surface after exposing the surface to one or more liquids;
(vi) exposing the surface to a corona discharge process;
(vii) scrubbing the surface with an abrasive material prior to or during exposure to fluid including liquid, air, or a combination thereof;
(viii) storing the substrate in a clean, dry, enclosed container to prevent contamination from dust or other particles;
(ix) applying a primer coating onto the surface;
(x) removing any excess primer coating from the surface; and
(xi) drying a primer coating on the surface.

5. The method of claim 1, wherein the substrate comprises a plastic, a metal, a metal-coated plastic substrate, a glass, or a combination thereof.

6. The method of claim 4, wherein the substrate comprises a plastic selected from the group consisting of polymethylmethacrylate (PMMA), polycarbonate, polyethylene terephthalate (PET), nylon, polyester, polypropylene, polyethylene, and combinations thereof; and the step of pre-treating comprises:
(i) contacting the surface with an aqueous pH neutral soap solution;
(ii) contacting the surface with a rinse of deionized water; and
(iii) drying the surface after exposing the surface to one or more liquids.

7. The method of claim 1, wherein the substrate comprises a metal substrate, and the step of pre-treating comprises:
(i) contacting the surface with an aqueous pH neutral soap solution;
(ii) contacting the surface with a trisodium phosphate (TSP) solution;
(iii) contacting the surface with an aqueous acidic solution;
(iv) contacting the surface with a rinse of deionized water; and
(v) drying the surface after exposing the surface to one or more liquids.

8. The method of claim 7, wherein the substrate comprises an aluminum substrate.

9. The method of claim 1, wherein the substrate comprises a metal-coated plastic substrate, and the step of pre-treating comprises:
(i) contacting the surface with an aqueous pH neutral soap solution;
(ii) contacting the surface with a trisodium phosphate (TSP) solution;
(iii) contacting the surface with a rinse of deionized water;
(iv) drying the surface after exposing the surface to one or more liquids;
(v) applying a primer coating onto the surface;
(vi) removing any excess primer coating from the surface; and
(vii) drying the primer coating on the surface.

10. The method of claim 1, wherein the substrate comprises a metal selected from the group consisting of brass, bronze, copper, and combinations thereof; and the step of pre-treating comprises:
(i) contacting the surface with an aqueous pH neutral soap solution;
(ii) contacting the surface with a rinse of deionized water;
(iii) drying the surface after exposing the surface to one or more liquids;
(iv) optionally, scrubbing the surface with an abrasive material prior to or during exposure to fluid including liquid, air, an acidic solution, or a combination thereof; and
(v) contacting the surface with an aqueous acidic solution.

11. The method of claim 1, wherein the curable protective coating further comprises at least one polymerizable material selected from the group consisting of dipentaerythritol hydroxy pentaacrylate (DPHPA); tripropylene glycol diacrylate (TRPGDA); an aliphatic urethane hexaacrylate; an acrylic functional, polyester modified dimethylpolysiloxane; and combinations thereof.

12. The method of claim 11, wherein the curable protective coating further comprises at least one polymerization initiator.

13. The method of claim 9, wherein the primer coating comprises at least one silane.

14. The method of claim 13, wherein the at least one silane comprises 3-methacryloxypropyltrimethoxysilane, N-(n-butyl) 3-aminopropyltrimethoxysilane, 3-glycidyloxypropyltrimethoxy silane, 3-mercaptopropyltrimethoxysilane, vinyltriethoxysilane, and combinations thereof.

15. The method of claim 6, wherein the adhesion promoter comprises propylene glycol methyl ether acetate, and the curable protective coating further comprises:
dipentaerythritol hydroxy pentaacrylate (DPHPA);
tripropylene glycol diacrylate (TRPGDA);
an aliphatic urethane hexaacrylate;
an acrylic functional, polyester modified dimethylpolysiloxane; and
at least one polymerization initiator selected from the group consisting of thermal initiators, photoinitiators, and combinations thereof.

16. The method of claim 7, wherein the adhesion promoter comprises propylene glycol methyl ether acetate, and the curable protective coating further comprises:
dipentaerythritol hydroxy pentaacrylate (DPHPA);
tripropylene glycol diacrylate (TRPGDA);
an aliphatic urethane hexaacrylate;
an acrylic functional, polyester modified dimethylpolysiloxane;
a silane; and
at least one polymerization initiator selected from the group consisting of thermal initiators, photoinitiators, and combinations thereof.

17. The method of claim 16, wherein the silane comprises 3-methacryloxypropyltrimethoxysilane.

18. The method of claim 9, wherein the primer coating comprises a silane and at least one acid; the adhesion promoter comprises propylene glycol methyl ether acetate, and the curable protective coating further comprises:
dipentaerythritol hydroxy pentaacrylate (DPHPA);
tripropylene glycol diacrylate (TRPGDA);
an aliphatic urethane hexaacrylate;
an acrylic functional, polyester modified dimethylpolysiloxane; and
at least one polymerization initiator selected from the group consisting of a thermal initiator, a photoinitiator, and combinations thereof.

19. The method of claim 18, wherein the silane comprises 3-methacryloxypropyltrimethoxysilane, and the at least one acid comprises phosphoric acid.

20. The method of claim 10, wherein the adhesion promoter comprises benzotriazole or a combination of benzotriazole and propylene glycol methyl ether acetate, and the curable protective coating further comprises:
dipentaerythritol hydroxy pentaacrylate (DPHPA);
tripropylene glycol diacrylate (TRPGDA);
an aliphatic urethane hexaacrylate;
an acrylic functional, polyester modified dimethylpolysiloxane; and
at least one polymerization initiator selected from the group consisting of thermal initiators, photoinitiators, and combinations thereof.

21. The method of claim 1, wherein the curable protective coating comprises less than 20 percent by weight of volatile material, based on a total weight of the curable protective coating.

22. The method of claim 1, wherein the curable protective coating comprises less than 3.0 percent by weight of volatile material, based on a total weight of the curable protective coating.

23. The method of claim 1, wherein the substrate forms at least a portion of an object, said object comprising an optical lens, eyeglasses, a contact lens, a credit card, a cellphone display, an automotive display, a personal data assistant (PDA), a pager, a video game, or a part having an optically clear component.

24. A pad printable curable protective coating comprising:
at least one adhesion promoter selected from the group consisting of glycol ethers, glycol ether acetates, benzotriazole, a silane, and combinations thereof;
at least one polymerizable material selected from the group consisting of dipentaerythritol hydroxy pentaacrylate (DPHPA); tripropylene glycol diacrylate (TRPGDA); an aliphatic urethane hexaacrylate; an acrylic functional, polyester modified dimethylpolysiloxane; and combinations thereof; and
at least one polymerization initiator;
wherein the curable protective coating contains less than 20 percent by weight of volatile material, based on a total weight of the curable protective coating.

25. A cured protective coating formed by exposing the pad printable curable protective coating of claim 24 to radiation.

26. An object having on a surface thereof the pad printable curable protective coating of claim 24.

27. The object of-claim 26, wherein the object comprises an optical lens, eyeglasses, a contact lens, a credit card, a cellphone display, an automotive-display, a personal data assistant (PDA), a pager, a video game, or a part having an optically clear component.

28. The object of claim 26, wherein the object comprises a plastic, a metal, a metal-coated plastic substrate, a glass, or a combination thereof.

29. The object of claim 26, wherein the object comprises a plastic selected from the group consisting of polymethylmethacrylate (PMMA), polycarbonate, polyethylene terephthalate (PET), nylon, polyester, polypropylene, polyethylene, and combinations thereof; and the curable protective coating comprises:
propylene glycol methyl ether acetate;
dipentaerythritol hydroxy pentaacrylate (DPHPA);
tripropylene glycol diacrylate (TRPGDA);
an aliphatic urethane hexaacrylate;
an acrylic functional, polyester modified dimethylpolysiloxane; and at least one
polymerization initiator selected from the group consisting of thermal initiators, photoinitiators, and combinations thereof.

30. The object of claim 26, wherein the object comprises an aluminum substrate, and the curable protective coating comprises:
propylene glycol methyl ether acetate;
dipentaerythritol hydroxy pentaacrylate (DPHPA);
tripropylene glycol diacrylate (TRPGDA);
an aliphatic urethane hexaacrylate;
an acrylic functional, polyester modified dimethylpolysiloxane;
a silane; and
at least one polymerization initiator selected from the group consisting of thermal initiators, photoinitiators, and combinations thereof.

31. The object of claim 30, wherein the silane comprises 3-methacryloxypropyltrimethoxysilane.

32. The object of claim 26, wherein the object comprises a metal-coated plastic substrate having a primer coating between the metal-coated plastic substrate and the curable protective coating, said primer coating comprising a silane and at least one acid; and said curable protective coating comprising:
propylene glycol methyl ether acetate;
dipentaerythritol hydroxy pentaacrylate (DPHPA);
tripropylene glycol diacrylate (TRPGDA);
an aliphatic urethane hexaacrylate;
an acrylic functional, polyester modified dimethylpolysiloxane; and
at least one polymerization initiator selected from the group consisting of thermal initiators, photoinitiators, and combinations thereof.

33. The object of claim 32, wherein the silane comprises 3-methacryloxypropyltrimethoxysilane, and the at least one acid comprises phosphoric acid.

34. The object of claim 26, wherein the object comprises a metal selected from the group consisting of brass, bronze, copper, and combinations thereof; and the curable protective coating comprises:
benzotriazole or a combination of benzotriazole and propylene glycol methyl ether acetate;
dipentaerythritol hydroxy pentaacrylate (DPHPA);
tripropylene glycol diacrylate (TRPGDA);
an aliphatic urethane hexaacrylate;
an acrylic functional, polyester modified dimethylpolysiloxane; and
at least one polymerization initiator selected from the group consisting of thermal initiators, photoinitiators, and combinations thereof.
